(19) United States
(12) Patent Application Publication
(10) Pub. No.: US 2025/0012652 A1
(43) Pub. Date: Jan. 9, 2025

(54) SPRING STRUCTURE AND METHOD FOR MANUFACTURING A SPRING STRUCTURE, CAPACITIVE PRESSURE SENSOR AND METHOD FOR MANUFACTURING A CAPACITIVE PRESSURE SENSOR

(71) Applicant: Fraunhofer-Gesellschaft zur Förderung der angewandten Forschung e.V., München (DE)

(72) Inventors: Yimei ZHANG, Itzehoe (DE); Hans-Joachim QUENZER, Itzehoe (DE)

(21) Appl. No.: 18/763,470

(22) Filed: Jul. 3, 2024

(30) Foreign Application Priority Data
Jul. 7, 2023 (DE) 102023206490.1

(51) Int. Cl. G01L 9/00; C03B 23/035

(52) U.S. Cl. CPC G01L 9/0075; C03B 23/0355

(57) ABSTRACT

According to an embodiment, a method for manufacturing a spring structure (glass spring structure) comprises: —providing a mold substrate and a cover substrate comprising a glass material, said mold substrate and said cover substrate being connected, wherein a surface area of the mold substrate and/or of the cover substrate is structured to form a closed (or enclosed or sealed) surrounding cavity between the cover substrate and the mold substrate, —tempering the cover substrate and the mold substrate to decrease the viscosity of the glass material of the cover substrate, and providing an overpressure in the closed surrounding cavity with respect to the ambient atmosphere, to cause, based on the decreased viscosity of the glass material of the cover substrate and the overpressure in the closed surrounding cavity with respect to the ambient atmosphere, bulging of the glass material of the cover substrate starting from the closed surrounding cavity to obtain a cover substrate provided with a surrounding glass bulge, and—(subsequently) removing the mold substrate from the cover substrate to obtain the spring structure with the surrounding glass bulge.

### CROSS-REFERENCE TO RELATED APPLICATION

This application claims priority from German Patent Application No. DE 10 2023 206 490.1, which was filed on Jul. 7, 2023, and is incorporated herein in its entirety by reference.

The present invention relates to a spring structure, a method for manufacturing a spring structure, a capacitive pressure sensor or absolute pressure sensor (e.g. using the spring structure), and a method for manufacturing a capacitive pressure sensor (e.g. using the method for manufacturing a spring structure).

In particular, the present invention relates to a manufacturing method for glass membranes (glass spring structures) with an adjustable elasticity as well to a corresponding glass membrane (spring structure) with an adjustable elasticity. According to embodiments, the present invention further relates to a capacitive pressure sensor with such an elastic glass membrane (glass spring structure) with an adjustable elasticity, and to a corresponding manufacturing method for such a capacitive pressure sensor using the method for manufacturing a spring structure.

### BACKGROUND OF THE INVENTION

Pressure sensors are very common in the field of technical sensors, and represent one of the most important and fundamental technical sensors. Capacitive pressure sensors are suited for a multitude of applications of measuring absolute pressures and pressure differences. Capacitive pressure sensors generally consist of a membrane that is deformable by pressure and that represents one of two capacitor plates of a capacitor. Due to the deformation, the distance between these two capacitor plates changes, thereby changing the capacity of the capacitor formed by the two capacitor plates.

Modern capacitive pressure sensors use a flat disc-shaped membrane, for example. In this case, the manufacturing methods for such a sensor membrane have to satisfy high requirements as to the precision, uniformity, and reproducibility. The thickness of the membrane as well as its uniformity and flatness significantly determine the sensitivity, the resolution, and the measurement range of the pressure sensor built therewith.

Planar membranes, no matter of which thickness, have a significantly non-linear characteristic curve (i.e. the relationship between the deflection and the effective force), wherein the resulting non-linearity already appears very significantly starting from a deflection that is larger than approximately one third of the membrane thickness. The characteristic curve output by the pressure sensors can only be linearized with very high efforts with respect to data processing and calibration of the sensors. However, loss of the sensitivity and the resolution cannot be avoided.

Planar, flat membranes, e.g. made of a semiconductor material such as silicon, are very sensitive with respect to axial stresses, i.e. stresses induced by tensile or pressure stresses in the plane of the membrane. For this reason, special care has to be taken in the assembly and connection technology to ensure that no high mechanical stresses act or are able to act on the membrane structure. Otherwise, the characteristic curve of the pressure sensor can change considerably, and when using materials with different thermal expansion, this behavior also depends on the ambient temperature.

The object of the present invention is to provide an improved method for manufacturing a capacitive pressure sensor and the elements used for the capacitive pressure sensor, in particular the deflection structure (spring structure), and to further provide a (correspondingly) improved capacitive pressure sensor and improved structural elements of the capacitive pressure sensor, e.g. an improved deflection structure (spring structure).

This object is solved by the subject-matter of the independent claims.

Specific designs, implementations and further developments of the present invention are defined in the dependent patent claims.

### SUMMARY

An embodiment may have a method for manufacturing a spring structure, comprising: providing a mold substrate and a cover substrate comprising a glass material, said mold substrate and said cover substrate being connected, wherein a surface area of the mold substrate and/or of the cover substrate is structured to form a closed surrounding cavity between the cover substrate and the mold substrate, tempering the cover substrate and the mold substrate to decrease the viscosity of the glass material of the cover substrate, and providing an overpressure in the closed surrounding cavity with respect to the ambient atmosphere, to cause, based on the decreased viscosity of the glass material of the cover substrate and the overpressure in the closed surrounding cavity with respect to the ambient atmosphere, bulging of the glass material of the cover substrate starting from the closed surrounding cavity to acquire a cover substrate provided with a surrounding glass bulge, and removing the mold substrate from the cover substrate to acquire the spring structure with the surrounding glass bulge.

Another embodiment may have a spring structure, comprising: a glass substrate, wherein the glass substrate comprises a surrounding glass bulge between an outer area and a deflectable inner area of the glass substrate, wherein the surrounding glass bulge is effective as a spring element between the outer area and the inner area.

Another embodiment may have a method for manufacturing a capacitive pressure sensor, comprising: performing the inventive method for manufacturing a spring structure, connecting the outer area of the spring structure to a base substrate to form a hermetically closed cavity between the spring structure and the base substrate, wherein the inner area of the spring structure and the opposite surface area of the base substrate are spaced apart so that the inner area of the spring structure is deflectable within the cavity with respect to the base substrate, wherein a capacitive structure is arranged at the base substrate opposite the deflectable inner area of the spring structure and the capacitive structure is formed to provide, on the basis of a deflection of the inner area of the spring structure, a capacitive change that is dependent on the deflection.

Another embodiment may have a capacitive pressure sensor comprising: the inventive spring structure, wherein the outer area of the spring structure is connected to a base substrate to form an hermetically closed cavity between the spring structure and the base substrate, wherein the inner area of the spring structure and the opposite surface area of the base substrate are spaced apart so that the inner area of the spring structure is deflectable with respect to the base substrate, and wherein a capacitive structure is arranged at the base substrate opposite the deflectable inner area of the spring structure, and the capacitive structure is configured to provide, based on a vertical deflection of the inner area of the spring structure, a capacitive change that is dependent on the deflection.

According to an embodiment, a method for manufacturing a spring structure (glass spring structure) comprises: —providing a mold substrate and a cover substrate comprising a glass material, said mold substrate and said cover substrate being connected, wherein a surface area of the mold substrate and/or of the cover substrate is structured to form a closed (or enclosed or sealed) surrounding cavity between the cover substrate and the mold substrate, —tempering the cover substrate and the mold substrate to decrease the viscosity of the glass material of the cover substrate, and providing an overpressure in the closed surrounding cavity with respect to the ambient atmosphere, to cause, based on the decreased viscosity of the glass material of the cover substrate and the overpressure in the closed surrounding cavity with respect to the ambient atmosphere, bulging of the glass material of the cover substrate starting from the closed surrounding cavity to obtain a cover substrate provided with a surrounding glass bulge, and—(subsequently) removing the mold substrate from the cover substrate to obtain the spring structure with the surrounding glass bulge.

According to a further embodiment, the cover substrate comprises a single homogenous glass material to form the spring structure (glass spring structure) with the surrounding glass bulge from this single homogenous glass material, wherein the surrounding glass bulge is arranged as a spring element between an outer area and an inner area of the cover substrate.

According to an embodiment, a spring structure comprises a (molded) glass substrate, wherein the glass substrate comprises a surrounding (continuous) glass bulge between an outer area and a deflectable inner area of the glass substrate, wherein the surrounding glass bulge is effective as a spring element between the outer area and the inner area. The inner area (“boss”) is deflectable, e.g. vertically, “relative” to the outer area by means of the surrounding glass bulge.

According to an embodiment, a method for manufacturing a capacitive pressure sensor (e.g. an absolute pressure sensor) comprises: —performing the (above) method for manufacturing a spring structure, —connecting the outer area of the spring structure to a base substrate to form a hermetically closed cavity between the spring structure and the base substrate, wherein the inner area of the spring structure and the opposite surface area of the base substrate are (vertically) spaced apart so that the inner area of the spring structure is deflectable within the cavity with respect to the base substrate, wherein a capacitive structure is arranged at the base substrate opposite the deflectable inner area of the spring structure and the capacitive structure is formed to provide, on the basis of a (vertical) deflection of the inner area of the spring structure, a capacitive change that is dependent on the (vertical) deflection.

According to an embodiment, the base substrate may comprise a recess to form the hermetically closed cavity between the spring structure and the base substrate, wherein the recess is part of the cavity, and the inner area of the spring structure is deflectable with respect to the recess.

According to an embodiment, the inner area of the spring structure may be arranged so as to be offset vertically with respect to the outer area of the spring structure (upwards—in the direction of the glass bulge) so that the inner area of the spring structure is deflectable within the cavity with respect to the base substrate.

According to an embodiment, (when connecting the spring structure to the base substrate) a surrounding spacer may be arranged outside of the (outermost) bulge between the outer area of the spring structure and the base substrate to provide the vertical distance (freewheel or free space or offset).

According to an embodiment, the above measures for providing the vertical distance, i.e. the freewheel or offset, between the outer area of the spring structure and the base substrate may also be combined. According to an embodiment, two or all of the measures may be combined to provide the vertical distance (freewheel or offset) between the outer area of the spring structure and the base substrate.

According to an embodiment, a capacitive pressure sensor (e.g. an absolute pressure sensor) comprises: the (above) spring structure, wherein the outer area of the spring structure is connected to a base substrate to form a hermetically closed cavity between the spring structure and the base substrate, wherein the inner area of the spring structure and the opposite surface area of the base structure are (vertically) spaced apart so that the inner area of the spring set structure is deflectable with respect to the base substrate, and wherein a capacitive structure is arranged at the base substrate opposite the deflectable inner area of the spring structure, wherein the capacitive structure is configured to provide, based on a vertical deflection of the inner area of the spring structure, a capacitive change depending on the (vertical) deflection.

Thus, the present invention is based on the finding that a novel spring structure, e.g. comprising a glass material or made of a glass material, may be provided. For example, the spring structure (glass spring structure) may be used as a deflectable membrane with a novel membrane geometry for a capacitive pressure sensor (e.g. an absolute pressure sensor) or for other applications or sensor applications. The spring structure, or glass spring structure, that can be used as a membrane structure for a capacitive pressure sensor, for example, may also be referred to as a Q membrane (omega membrane) due to its characteristic cross-sectional shape. For example, due to its similarity with the curved shape of the Q in the cross-sectional view, the shape of the spring structure may also be referred to as a Q spring structure or Q membrane in the subsequent description.

Thus, the spring structure comprises a glass material or consists of a glass material. The actual Q part, i.e. the surrounding continuous (=not divided along the (lateral) circumference) glass bulge comprising a (vertical) cross section in the form of a superimposed circular segment does not comprise a homogeneous thickness across its Q cross section, for example. Thus, for example, the spring structure (membrane) may have the thinnest glass material at the tip, or at the apex, of the surrounding glass bulge. Due to the symmetry, or the rotational symmetry, of the entire spring structure (membrane), the Q structure has a uniform thickness following the shape of a torus (e.g. has a uniform thickness or thickness distribution following the shape of a torus—the thickness of the bulge is the same in a sectional plane parallel to the reference plane).

The spring structure, e.g. which may be used as a membrane with a deflectable inner area for a capacitive pressure sensor, therefore has a novel membrane geometry, e.g., (approximately) comprising a torus with a cross section in the form of a superimposed three-quarter circle, or a superimposed circular segment.

The surface of the glass substrate surrounded by the glass bulge (Q structure), i.e. the so-called “boss”, is significantly thicker and therefore stiffer than the actual flexible glass bulge (Ω structure=spring element). Thus, the extent of bending that the (deflectable) intermediate area (boss) experiences is negligible in a first approximation, i.e. the forces, in particular, pressure forces, acting on this area are directly transmitted to the Q structure.

The inventive spring structure and the capacitive pressure sensor built with this glass spring structure as well as the respective manufacturing methods have significant advantages over the conventional technology, e.g. silicon-membranes for pressure sensors, obtained by an etching process.

Through the local expansion of the glass, the relative uniformity in the thickness of the glass wafer is also maintained in the uniformity in the omega structure. For example, when using a glass wafer with a thickness of 400 μm (or 300-500 μm) with a thickness variation of 1% across the wafer, the thicknesses in an omega membrane with a thickness of 40 μm (or 35-45 μm) vary with approximately 1% assuming the same inflation height), corresponding to an accuracy of 0.4 μm (or 0.35-0.45 μm) in the membrane thickness of the glass.

The spring effect in the omega structure (glass bulge=spring element) is achieved due to the fact that the circumference of the torus, the spring length so to speak, is significantly increased by undercutting the original trench structure. The maximum lateral extension (the maximum lateral diameter) of the bulge is larger than the lateral diameter (a lateral width) of the surrounding cavity. This makes it possible to construct from an originally rather small structure a rather long spring, which is of particular importance for the construction of small compact sensors.

For the construction of capacitive sensors, it is of further advantage that the central plate occupying a large part of the surface area of the membrane, since the actual spring element is largely behind this plate, remains planar and does practically not experience any deformation or bulge, as would be the case for a membrane having a continuously homogenous thickness. This achieves a greater change of the measuring capacity, resulting in a better sensitivity of the capacitive pressure sensor with plate electrodes.

On the basis of its height, the elasticity of the omega spring (of the spring element) may be set or checked and possibly readjusted subsequently by further tempering during manufacturing.

Since the spring structures are curved, the force-path characteristic curve of these membranes is linear across a broad pressure or force range. Planar membranes show a strongly non-linear behavior as soon as their deflection exceeds a height of approximately 20-30% of the membrane thickness, since the planar membrane becomes stiffer due to the mechanical tensile stresses induced by the deflection.

The special shape of the omega membrane also enables lateral movement. However, transverse forces, e.g. acting laterally on the membrane when assembling sensor, have only a comparably small influence on the elasticity and therefore on the force-path characteristic curve of the pressure sensor. However, in conventional pressure sensors, lateral transverse forces, e.g. that may occur due to mechanical stresses during assembly of the component, cause a significant change of the characteristic curve, above all in the sensitivity of the sensor.

This inventive sensor, or its spring structure, mainly comprises glass (a glass material) or mainly consists of glass. Thus, the sensor is very chemically durable and has great stability. In addition, the membrane and the base plate of the sensor may be manufactured of the same glass material with the same coefficients of thermal expansion. Furthermore, the membrane of the sensor may be made from or may be manufactured of a glass material and the base plate may be manufactured of a semiconductor material with essentially the same coefficients of thermal expansion. Through this, the effects of temperature changes with respect to the sensor characteristic curve may be minimized.

Glass as a membrane material is hermetically tight, i.e. the volume below the membrane may be evacuated, and, assuming a hermetically tight connection between the membrane and the sensor base, may be maintained across long durations. Through this, it is possible to manufacture an absolute pressure sensor with a glass membrane.

Glass, as a purely dielectric material, is well suited for the construction of capacitive sensors. In this case, e.g. silicon is of disadvantage since parasitic capacities can practically not be avoided when using silicon due to its remaining electric conductivity, but also due to its dielectric constant.

Furthermore, the radius of the omega springs depends on process parameters that cannot be controlled very well. Since the physical situations are well known and defined, the manufacturing process may be described and simulated, which is why the elasticity of the omega membrane may be predicted and adjusted precisely.

Glass as the material and the glass flow technology enable cost-efficient manufacturing for the pressure sensor.

According to an embodiment, the width b and the height h of the surrounding glass bulge may vary to form an asymmetrically surrounding glass bulge. Due to the shape and size of the glass bulge, the resulting spring stiffness (elasticity) of the spring element of the spring structure may be adjusted. Through this, an asymmetric omega membrane may be obtained, e.g. for optical pressure sensors.

When using an omega structure with a different width, instead of a concentric omega membrane, a membrane having its central planar area experience a tilt upon deflection may be manufactured.

For example, this could be used to construct an optical pressure sensor. In the simplest case, this may be done by a light beam that is deflected from the central planar surface. If the prevalent external pressure changes, the membrane experiences deflection and tilting, deflecting the light beam accordingly, which can be captured by suitable detectors, e.g. a line scan camera.

In addition to the applications in pressure sensors, the special membrane technology can be used when very precise spring elements in the form of a closed membrane are required. Examples include pressure switches, pressure relief valves and non-return valves in fluidic microsystems.

In addition, there are other applications that profit from a flexible transparent membrane structure, such as UV LEDs. Here, as part of a cap of a closed housing, the flexible glass structure would sit in contact on the semiconductor of the LED (in particular its polished rear side), as a result of which light could be efficiently guided out of the LED without additional use of a transparent casting compound.

### BRIEF DESCRIPTION OF THE DRAWINGS

Embodiments of the present invention will be detailed subsequently referring to the appended drawings, in which:

FIG. 1 shows a schematic flow diagram of the inventive manufacturing method according to an embodiment;

FIG. 2 shows an exemplary principal flow diagram of the inventive manufacturing method according to a further embodiment;

FIG. 3 shows an exemplary principal flow diagram of the inventive manufacturing method according to a further embodiment (for providing a vertically offset inner area of the spring structure);

FIGS. 4a-c show exemplary embodiments of a spring structure (glass spring structure) according to an embodiment;

FIG. 5 shows a schematic flow diagram of the inventive manufacturing method for a capacitive pressure sensor according to a further embodiment;

FIG. 6 shows an exemplary principal flow diagram of the inventive manufacturing method for a capacitive pressure sensor according to a further embodiment;

FIG. 7 show a further exemplary principal flow diagram of the inventive manufacturing method for a capacitive pressure sensor according to a further embodiment;

FIGS. 8a-b show exemplary embodiments of a capacitive pressure sensor according to further embodiments;

FIGS. 9a-c show exemplary embodiments of the capacitive structure at the base substrate and/or the spring structure of a capacitive pressure sensor according to further embodiments;

FIGS. 10a-b show force-path diagrams of the inventive spring structure compared to conventional silicon membranes.

### DETAILED DESCRIPTION OF THE INVENTION

Before subsequently describing embodiments of the present invention in detail on the basis of the drawings, it is to be noted that identical and functionally and effectively identical elements, objects, functional blocks, and/or method steps are provided in different drawings with the same reference numerals so that the description of these elements, objects, functional blocks and/or method steps (with the same reference numerals) illustrated in the different embodiments are interchangeable or may be applied to one another.

In the following description, the description of an element consisting of a semiconductor material refers to the fact that the element comprises a semiconductor material, i.e. it is at least partially or even fully made of the semiconductor material. In the subsequent description, the description of an element being made of a glass material means that the element comprises a glass material, i.e. it is at least partially or even fully made of the glass material.

It is understood that when an element is referred to as being “connected” or “coupled” to another element, it may be directly connected or coupled to the element or there may be intermediate elements in between. On the contrary, if an element is referred to as being “directly connected” or “directly coupled” to another element, there are no intermediate elements in-between. Other expressions used to describe the relationship between elements should be interpreted similarly (e.g. “between” compared to “directly between” “adjacent” compared to “directly adjacent”, etc.)

To simplify the description of the different embodiments, at least some of the drawings comprise a Cartesian coordinate system x, y, z, wherein the directions x, y, z is arranged so as to be orthogonal with respect to each other. In the embodiments, the x-y plane corresponds to the main surface area of a carrier or a substrate (=reference plane=x-y plane), wherein, upwards with respect to the reference plane (x-y plane), the direction vertical thereto corresponds to the “+z” direction, and wherein, downwards with respect to the reference plane (x-y plane), the direction vertical thereto corresponds to the “−z” direction. In the following description, the expression “lateral” refers to a direction in parallel to the x and/or y direction, i.e. in parallel to the x-y plane, wherein the expression “vertical” indicates a direction in parallel to the +/−z direction.

In the context of the present invention, terms and/or text passages placed in brackets are to be understood exemplarily as further explanations, e.g. implementations, additions and/or exemplary alternatives (to the preceding term or the preceding text passage).

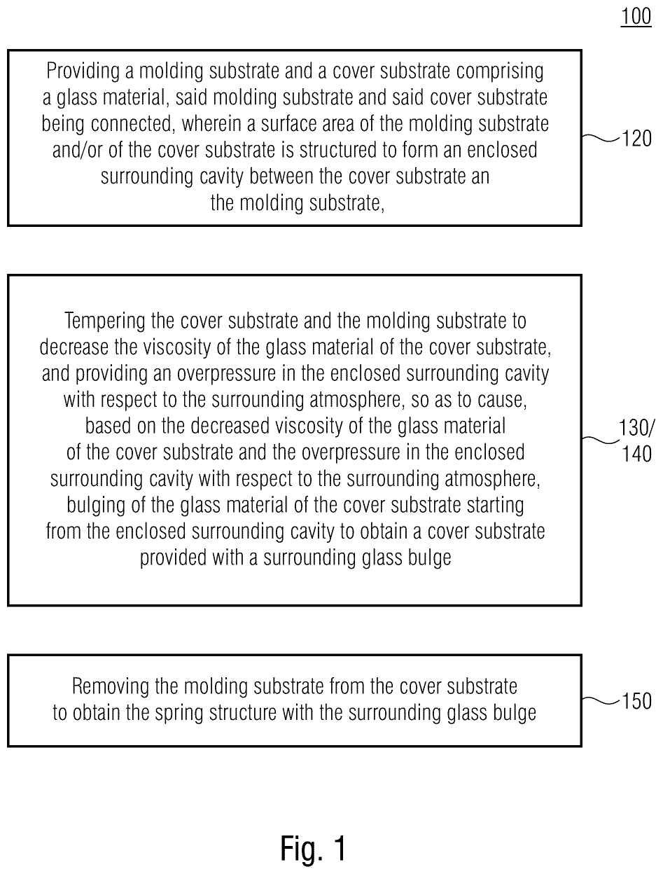

In the following, a principal flow diagram of the inventive method 100 for manufacturing a spring structure (glass spring structure) according to an embodiment is exemplarily described on the basis of FIG. 1. The spring structure obtained in the manufacturing method 100 may be used to manufacture a capacitive pressure sensor (e.g. an absolute pressure sensor) or further other sensor arrays, for example, requiring or using very precise spring elements in the form of a closed membrane.

With reference to the method 100 of FIG. 1, in step 120, a mold substrate and a cover substrate comprising a glass material are provided. The cover substrate may also consist of the glass material. The mold substrate and the cover substrate (glass substrate) are connected (bonded) to the each other, wherein the surface area of the mold substrate and/or the cover substrate is structured to form one (or several) closed (or enclosed or sealed) surrounding (continuous) cavities between the cover substrate and the mold substrate (glass substrate).

In a (subsequent) step 130, the cover substrate and the mold substrate are tempered, i.e. subjected to temperature treatment or heated to decrease the viscosity of the glass material of the cover substrate.

Furthermore, in step 140, an overpressure is provided in the (at least one) closed surrounding (continuous) cavity with respect to the ambient atmosphere to cause, on the basis of the decreased viscosity (decreased by tempering) of the glass material of the cover substrate and the overpressure in the (at least one) closed surrounding cavity with respect to the ambient atmosphere, bulging, e.g. blow-out or deformation, of the glass material of the cover substrate starting from the closed surrounding cavity to obtain a cover substrate provided with (at least) one surrounding glass bulge.

Selectively bulging the glass material due to the overpressure in the closed cavity and due to the decreased viscosity of the glass material may also be referred to as blow-out or deformation of the glass material. By selectively bulging the glass material of the cover substrate, a (molded) cover substrate with the surrounding (continuous) bulge (glass bulge) is obtained.

In a (subsequent) step 150, the mold substrate is at least partially or fully removed from the cover substrate to obtain the spring structure (glass spring structure) with the surrounding glass bulge. Since the cover substrate 200 comprises a “single” homogenous glass material or consists thereof, for example, the spring structure is also integrally formed of the homogenous glass material.

Since the inventive method for manufacturing a spring structure uses a mold substrate comprising a semiconductor material, e.g. which is configured as preprocessed silicon wafer, the following will also refer to the silicon mold substrate or silicon wafer. However, it should be clear that the use of silicon for the mold substrate (semiconductor wafer) is only exemplary, wherein, depending on the application case or manufacturing process, other suitably processable materials or semiconductor materials may be used for the mold substrate.

According to an embodiment, the mold substrate may be configured as a semiconductor substrate (semiconductor wafer or silicon wafer) and the cover substrate may be configured as a glass substrate or glass wafer. According to an embodiment, the mold substrate and the cover substrate are hermetically connected or joined (e.g. for the tempering process), e.g. which may be achieved with an anodic bonding process or another joining process. Furthermore, a surface area of the mold substrate and/or of the cover substrate is provided with a recess or several recesses to form the (at least one) surrounding cavity between the cover substrate and the mold substrate.

For example, the mold substrate is a substrate with a shape, contour, or topography, such as a topographically structured substrate. For example, the mold substrate may be configured as semiconductor wafer, such as a silicon wafer, wherein the surface structuring or the topography of the mold substrate may be obtained in a very precise way by means of semiconductor processing steps (e.g. silicon processing steps). Such semiconductor processing methods, such as photolithographic processes with wet or dry etching processes, are technically well mastered. Furthermore, mechanical surface processing methods, e.g. for CNC milling, may be used for forming the structure in the mold substrate. Furthermore, in addition to semiconductor materials, such as Si, SiGe, other materials, such as AlN, SiC, high-melting glass (e.g. Schott AF 32), may be used for the mold substrate, said materials being suitable for a photolithographic or mechanical surface processing method for forming the structure in the mold substrate and further being sufficiently temperature-stable in the tempering processes (temperature processing methods) during the method for manufacturing the cap substrate.

As indicated above, the cover substrate according to an embodiment comprises a single homogeneous material, such as a glass material, to form the molded cover substrate, i.e. the spring structure (glass spring structure), from a single homogeneous glass material.

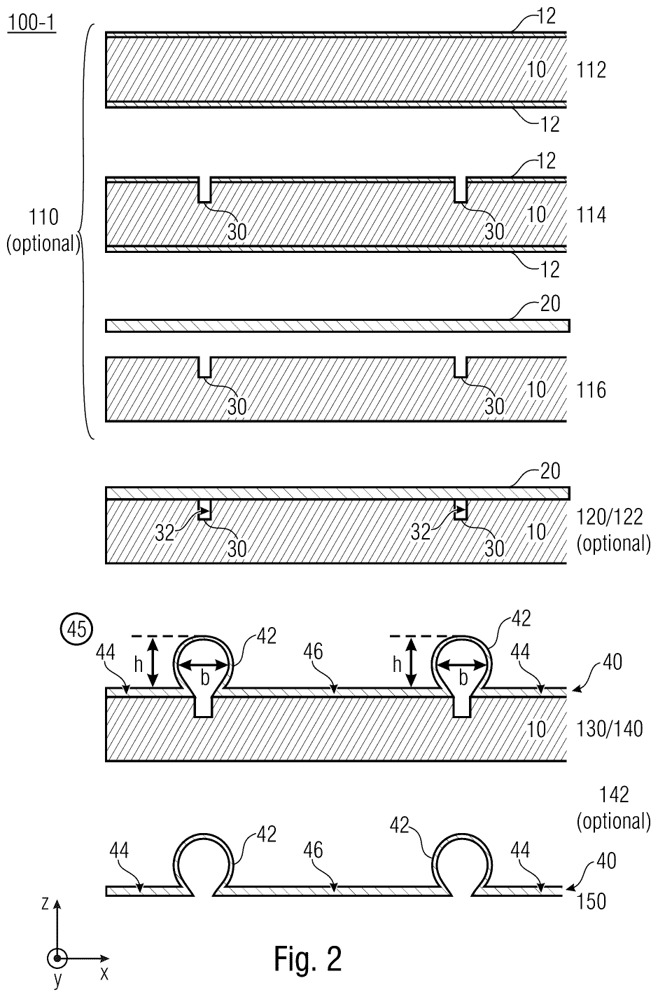

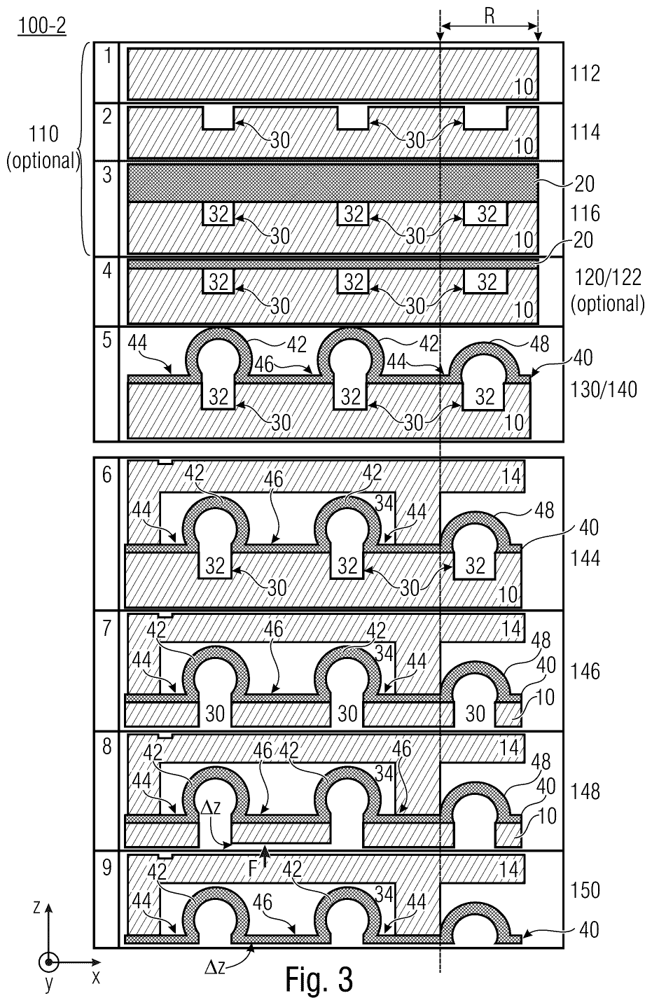

In this connection, e.g., reference is made to FIGS. 2-3 and the associated description of the principal flow diagram of possible implementations of the inventive manufacturing method 100, in which the method steps are shown or implemented.

In the context of the present invention, an inorganic amorphous material, e.g. based on a silicate or several silicates, whose viscosity decreases within increasing temperature (e.g. continuously) is referred to as a glass material. For example, the glass material used exemplarily comprises a coefficient of thermal expansion adapted to the semiconductor material (e.g. silicon) of the mold substrate. In such a way, the coefficients of thermal expansion of the glass material of the cover substrate and the semiconductor material of the mold substrate may be selected to obtain a difference of less than or equal to 1 ppm/K (or less than or equal to 5 ppm/K). Due to the small difference of the coefficients of thermal expansion of the materials of the mold substrate and the cover substrate, hermetically tight connections may be achieved without the substrate being destroyed during cooling so that the (at least one) closed surrounding (continuous) cavity may be obtained between the cover substrate and the mold substrate in a hermetically tight way by means of a temperature-controlled bonding process.

In the context of the present description, tempering (cf. step 130) is temperature processing, for example temporally controlled homogenous heating, wherein this tempering step is exemplarily performed in a selectively controllable pressure environment, i.e. with selectively controlled ambient pressure conditions. According to an embodiment, step 130 of tempering may be performed in a temperature range above 650° C., e.g. between 650° C. and 955° C. or between 650° C. and 750° C.

The illustrated method is essentially based on techniques of so-called glass flow processes. In the embodiments, the glass material of the substrate may be Borofloat® glass or a different glass such as Schott AF 32, Corning Eagle XG, Hoya SD2. The coefficient of thermal expansion (CTE) of the glass material is selected to match the semiconductor material used, since manufacturing the cap wafer (cap substrate) as well as bonding the cap wafer are carried out on the semiconductor material of the mold substrate, e.g. on a silicon substrate. Differences in the coefficient of thermal expansion that are too large could otherwise lead to very large thermal mechanical stresses or to the destruction of the elements involved (e.g. in tempering) if the CTE of the glass material of the cover substrate does not match the CTE of the semiconductor material of the mold substrate (e.g. within a tolerance range of less than 0.01%, 0.1% or 1%). For example, matching means that the CTE of the glass material in embodiments does not deviate by more than 2-1 ppm/K or not more than 5 ppm/K from the CTE of the semiconductor material. In the embodiments, the CTE of the glass material deviates from the CTE of the semiconductor material by less than 0.5 ppm/K, for example.

According to an embodiment, the cover substrate may comprise a single homogeneous glass material to form the spring structure with the surrounding glass bulge from this single homogeneous glass material, wherein the surrounding glass bulge is arranged as a spring element between an upper area and an inner area of the (“boss) of the cover substrate.

According to an embodiment, the continuous surrounding cavity is configured to be circularly surrounding, elliptically surrounding, or ovally surrounding to configure a circularly surrounding, elliptically surrounding, or ovally surrounding glass bulge in the steps of tempering and providing an overpressure.

According to an embodiment, the surrounding cavity may comprise a constant width to obtain a symmetrically surrounding glass bulge in the steps of tempering and providing an overpressure.

By blowing the omega spring structure, the glass in this area is expanded and thinned simultaneously. Ultimately, both effects increase the flexibility of the spring structure. In this case, the elasticity of this spring structure depends on the thickness of the initial glass and the aspect ratio (ratio of height to width) of the omega structure.

According to an embodiment, the surrounding cavity may also comprise a (continuously) varying width to obtain an asymmetrically surrounding glass bulge in the steps of tempering and providing an overpressure.

The form and size of the cavity and the extent of the bulge process may be used to set the shape and size of the glass bulge and therefore the resulting spring stiffness (elasticity) of the spring structure.

According to an embodiment, the step of providing a mold substrate and a cover substrate may comprise the following (optional) steps (sub-steps).

First, in an optional step 110, the mold substrate, e.g. a semiconductor wafer or Si wafer, with the structured (=provided with recesses) surface area is provided. Furthermore, the cover substrate, e.g. a glass wafer, is provided.

Step 110 may now exemplarily include several optional sub-steps 112, 114, 116. In step (sub-step) 112, e.g., the mold substrate, e.g. a silicon wafer, is provided with a thickness of 725 μm (or between 650 and 800 μm). For example, the mold substrate may be coated on one side or on both sides with a protective varnish. After a photolithographic surface treatment of the mold substrate, the mold substrate is now structured in step (sub-step) 114, i.e. provided with the surrounding continuous recess, e.g. subsequently corresponding to the surrounding continuous cavity. For example, the photolithographic process is carried out by exposing the protective varnish to light, wherein the structured surface area is subsequently formed with high-rate etching, i.e. the trenches with a depth of 225 μm (or between 175 and 275 μm) are formed in the main surface area of the mold substrate. For example, the etching process can be a DRIE (DRIE=Deep Reactive Ion Etch etching) process.

In step 116, the cover substrate is arranged on the structured surface area of the mold substrate, wherein the cover substrate comprises a glass material or consists thereof. Thus, for example, the surface area of the cover substrate adjacent to the mold substrate (opposite thereto) may be configured to be planar (=without recesses).

In step 120, the cover substrate is now connected or joined to the mold substrate, e.g. it is hermetically connected by means of anodic bonding or a different joining technique, to form at least one closed surrounding cavity (or a plurality of closed cavities) between the cover substrate and the mold substrate. In this case, the recess arranged in the mold substrate or the recesses arranged the mold substrate then form the at least one closed cavity between the cover substrate and the mold substrate.

According to an embodiment of the method, (hermetically) connecting the cover substrate to the mold substrate is carried out in an atmosphere with a defined atmospheric ambient pressure to enclose a defined atmospheric pressure in the closed cavities. In this context, reference is also made, for example, to the embodiments illustrated with reference to FIGS. 2-3 and the associated description.

The cover substrate (glass wafer, e.g. BF33) may, for example, have a thickness of approximately 400 μm, wherein a pressure of 1200 mbar (or between 1100 and 1300 mbar compared to a normal atmospheric ambient pressure) is enclosed in the (at least one) surrounding cavity during the bonding process. Finally, in a further optional intermediate step 122, the covering substrate (glass wafer) may be ground back to a thickness of about 125 μm (or between 100 and 150 μm), for example by performing a CMP (chemical-mechanical polishing) operation on the glass surface (e.g. with a removal of 5 μm) to obtain the resulting target thickness of the cover substrate (glass wafer) of about 120 μm (or between 100 and 140 μm).

According to an embodiment of the method 100, the surface area of the mold substrate and/or the cover substrate is structured (provided with circumferential recesses or indentations) to form a plurality of closed surrounding cavities between the cover substrate and the mold substrate, said cavities being arranged concentrically and/or parallel to each other. According to an embodiment of the method 100, the closed surrounding cavities, which are closed off from the ambient atmosphere, can be arranged fluidically separated from each other. According to a further embodiment, gas exchange channels may furthermore be provided between the cavities closed off from the ambient atmosphere to connect them fluidically to one another to obtain a common defined atmospheric pressure in the connected cavities

According to an embodiment of the method 100, the step of tempering and providing an overpressure is carried out as a glass flow process in a vacuum furnace (or negative pressure furnace) to obtain a defined atmospheric overpressure in the (at least one) closed surrounding cavity with respect to the ambient atmosphere. In this context, reference is also made, for example, to FIGS. 2-3 and the associated description.

According to an (above described) embodiment of the method 100, the surface area of the mold substrate and/or of the cover substrate may be structured (provided with surrounding recesses) to form (to configure) a plurality of closed surrounding cavities between the cover substrate and the mold substrate, said cavities being arranged concentrically and/or parallel with respect to each other.

According to an embodiment of the method 100, in the step of tempering the cover substrate and the mold substrate and the step of providing an overpressure in the closed surrounding cavities with respect to the ambient atmosphere, bulging of the glass material of the cover substrate may be caused starting from the closed surrounding cavity to obtain a cover substrate provided with a plurality of surrounding glass bulges arranged concentrically (in parallel) with respect to each other. Bulging of the glass material of the cover substrate (glass substrate) is based on the decreased viscosity (decreased due to tempering) of the glass material of the cover substrate and the overpressure in the closed surrounding cavities with respect to the ambient atmosphere.

According to an embodiment of the method 100, several surrounding bulges of the glass material may be created in the cover substrate. In circularly surrounding bulges of the glass material in the cover substrate, the plurality of surrounding glass bulges is arranged concentrically (and in parallel) with respect to each other, for example. In case of elliptically surrounding or ovally surrounding glass bulges in the cover substrate, the plurality of surrounding glass bulges is arranged in parallel to each other.

A plurality of (neighboring) surrounding glass bulges in the cover substrate may be considered as a serial array of spring elements for setting the desired spring constant of the spring element of the spring structure. The explanations for manufacturing the spring structure with “one” glass bulge illustrated in the present description can equally be applied to manufacturing the spring structure with a plurality of glass bulges on the basis of a plurality of cavities between the cover substrate and the mold substrate.

According to an embodiment of the method 100, step 150 of (fully or at least partially) removing the cover substrate may be performed by means of an etching process, i.e. the silicon material or semiconductor material of the mold substrate may be removed with a silicon or semiconductor etching process, e.g. in hot potassium hydroxide solution. Removing 150 may also mean separating the semiconductor material of the mold substrate by means of an etching process (silicon or semiconductor etching process of the silicon or semiconductor material) from the cover substrate.

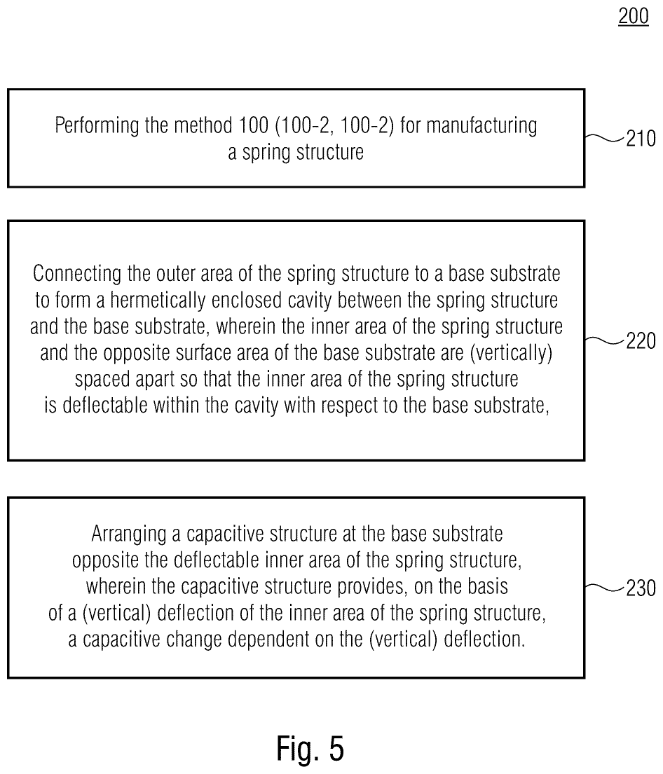

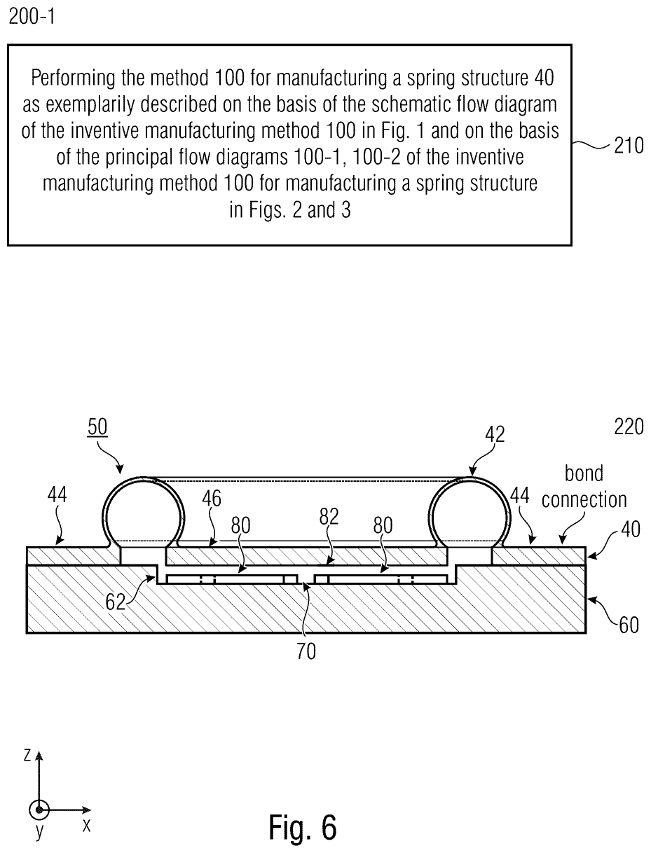

According to an embodiment of the method 100, in the step of removing the mold substrate (base substrate) by means of an etching process, interdigital structures may be selectively formed (configured) in the mold substrate. Thus, the interdigital structures may be configured on the main surface area, facing away from the glass bulge, of the inner area (intermediate area) of the spring structure. This interdigital structure may then remain at the inner area of the molded cover substrate to form a part of the capacitive structure for the capacitive pressure sensor. In this connection, e.g. reference is made to FIGS. 5-9 and the associated description.

According to an embodiment of the method 100, a vertical offset, i.e. a height offset may be created in the direction of the bulge (in the bulging direction) between the inner area and the outer area of the spring structure so that the inner area is offset vertically in the bulging direction with respect to the outer area of the spring structure. To this end, e.g. the following additional steps may be performed (after manufacturing the spring structure).

According to an embodiment, the cover substrate provided with a glass bulge is (again) tempered (post-tempered) to decrease the viscosity of the glass material of the cover substrate provided with the bulge. Since the glass bulge comprises a thickness that is significantly smaller (≤10%) than the inner and outer area of the spring structure, little heat input is sufficient to sufficiently decrease the viscosity of the glass material of the glass bulge.

Subsequently, a force is applied to the inner area of the spring structure in the direction of the bulge (in the bulging direction) to create the vertical offset (height offset) between the outer area and the inner area of the spring structure in the direction of the bulge (in the bulging direction). As soon as the increased temperature has decreased back to the normal range, the offset remains between the outer area and the inner area of the spring structure.

In the following, some method steps of the method or process 100 of FIG. 1 are summarized (in other words) and described exemplarily again.

The design of the omega membrane is mainly specified by the special manufacturing method, the so-called glass flow process. In this case, e.g. a glass wafer on an Si-wafer with introduced recesses is tightly closed and a defined gas volume is closed therewith. In the subsequent tempering, the glass is softened and blown out by the enclosed gas, as a result of which the blown-out (or inflated) structure is ultimately created. Subsequently, the Si-wafer is selectively removed from the glass by etching.

For manufacturing the omega membrane, an annular structure is introduced into the silicon wafer and is reshaped by means of the glass flow process into a toroidal structure and the silicon wafer is subsequently etched off. In this case, the surrounding omega structure forms an annular mechanical spring, while the area surrounded by the omega structure functions as a central stiffening in the center of the membrane.

By blowing out the omega spring structure, the glass is simultaneously expanded and thinned in this area. Both effects ultimately increase the flexibility of the spring element (of the glass bulge) of the spring structure. The elasticity of this spring structure depends on the thickness of the initial glass and the aspect ratio (ratio of height to width) of the omega structure.

Depending on the process setup, different base shapes of the omega membrane may be manufactured.

In a (simplest) case, the toroidal structure is blown out to heights of twice to four times the value of the membrane thickness. In this case, the glass membrane expands locally and becomes thinner, however, there is no over-blowing, i.e. the resulting glass structure remains within the structural range specified by the etched torus in the underlying substrate.

When continuing the blowing process, the width of the torus ultimately becomes significantly larger than the width of the trench in the substrate and expands significantly in the direction of the sides—the actual omega membrane is created. In this case, torus heights exceeding multiple times the thickness of the original glass substrate may be created. In this process, the walls of the torus are thinned significantly, and the circumference of the torus is significantly increased, creating a surrounding but still closed spring element (glass bulge) of the spring structure.

The elasticity of these spring elements of the spring structure may be set by the extent of the blow-up across a wide range of the spring constant.

FIG. 2 shows an exemplary principal flow diagram 100-1 of the inventive manufacturing method 100 for manufacturing a spring structure according to a further embodiment.

In the preparation of the actual manufacturing process, e.g. in the optional step 110 (with the partial steps 112, 114, 116), the mold substrate 10, e.g. a silicon mold substrate, is provided with single-side cavities 12 (=recesses) and is provided together with the cover substrate (glass wafer) 20.

In the optional step (sub-step) 112, e.g. the mold substrate 10, e.g. a silicon wafer, is provided with a thickness of 725 μm (or between 650 and 800 μm). For example, the mold substrate 10 may be coated on one side or on both sides with a protective varnish 12. After a photolithographic surface treatment of the mold substrate 10, in the optional step (sub-step) 114, the mold substrate 10 is now structured, i.e. provided with the surrounding continuous recess 30, e.g., which subsequently corresponds to the surrounding continuous cavity 32. For example, the photolithographic process is carried out by exposing the protective varnish 12 to light, wherein the structured surface area of the mold substrate 10 is subsequently formed by means of high-rate etching, i.e. trenches 30 with a depth of 225 μm (or between 175 and 275 μm) are formed in the main surface area of the mold substrate 10. For example, the etching process may be performed with a DRIE process (DRIE=Deep Reactive Ion Etching). In the optional step 116, the mold substrate 20 is provided, wherein the cover substrate 20 comprises a glass material or consists thereof. Thus, for example, the surface area of the cover substrate 20 adjacent to the main surface area of the mold substrate 10 may be configured to be planar (=without recesses). For example, the cover substrate (glass wafer, e.g. BF33) may comprise a thickness of approximately 400 μm (or between 300 and 500 μm).

In step 120, the glass wafer 20 is aligned in the direction of the mold substrate 10 and is anodically bonded in a specified atmosphere, for example, to enclose (or trap) a (defined) gas pressure (e.g. an atmospheric overpressure) in the cavity 32. According to an embodiment of the flow diagram 100-1 of the method 100, the cover substrate 20 and/or the mold substrate 10 are configured to form the (at least one) closed surrounding (continuous) cavity 32 between the cover substrate 20 and the mold substrate 10.

Thus, in step 120, the mold substrate 10 and the cover substrate 20 connected to each other are provided, wherein the main surface area of the mold substrate is structured, i.e. it comprises a surrounding recess or a surrounding channel 30, to form the at least one closed surrounding cavity 32 between the cover substrate 20 and the mold substrate 10. Thus, in step 120, e.g. an anodically bonded glass-silicon substrate stack 10, 20 is obtained or provided.

In the bonding process 120, e.g., a pressure of 1200 mbar is enclosed in the (at least one) surrounding cavity 32. Finally, in a further optional intermediate step 122, the cover substrate (the glass wafer) may be ground back to a thickness of approximately 125 μm (or between 100 and 150 μm) by means of a CMP process.

In the (subsequent) step 120, the cover substrate 20 and the mold substrate 10 are now tempered, i.e. subjected to temperature processing, or heated, to decrease the viscosity of the glass material of the cover substrate 20. Furthermore, in a step 140, an overpressure is provided in the (at least one) closed surrounding cavity 30 with respect to the ambient atmosphere to cause, based on the decreased (through tempering) viscosity (decreased through tempering) of the glass material of the cover substrate 20 and the overpressure in the closed cavity 32 with respect to the ambient atmosphere, a defined bulging, e.g. a blow-out or deformation, of the glass material of the cover substrate 20 starting from the closed surrounding cavity 30. The defined bulging of the glass material and the cover substrate 20 due to the overpressure in the closed cavity 32 and the decreased viscosity of the glass material may also be referred to as blow-out or deformation of the glass material of the cover substrate 20. Through the defined bulging of the glass material of the cover substrate 20, a molded cover substrate 40 with the surrounding bulge or deformation 42 of the glass material is obtained. Thus, the obtained bulge or deformation of the molded cover substrate is referred to as the spring element 42. According to an embodiment, the step 130 of tempering may be carried out in a temperature range above 650° C., e.g. between 650° C. and 955° C. or between 650° C. and 750° C.

Through the shape and size of the cavity and the extent (the duration and temperature) of the bulging process, the shape and size of the resulting glass bulge and the resulting spring stiffness (elasticity) of the spring element of the spring structure may be set.

According to an embodiment of the flow diagram 100-1 of the method 100, the step of tempering 130 and providing 140 an overpressure may be performed as a glass flow process in a vacuum furnace 45 to obtain a defined atmospheric pressure or overpressure in the closed cavity 32 with respect to the ambient atmosphere.

According to an embodiment of the flow diagram 100-1 of the method 100 of FIG. 2, in the step of tempering 130 and providing 140 an overpressure in the area of the closed cavity 30, the cover substrate 20 is bulged or blown out up to a height h (at the tip or the apex of the surrounding glass bulge 42) with a resulting maximum width b.

In the case of an exemplary thickness of the cover substrate 20 of 80-150 μm, e.g. approximately 100 or 120 μm, the height h may be in a range of between 200-600 μm, e.g. approximately 400 μm, and the width b may be in a range of 200-600 μm, e.g. approximately 400 μm.

Performing the glass flow process 130, 140 may be carried out in a pressure-controlled furnace 45. The glass wafer (the cover substrate) 20 is blown up to a height h in the area of the cavities 30. After the glass flow process 130, 140, the substrate stack 10, 20 is cooled down and the substrate stack 10, 20 is removed from the furnace 45. After the glass flow process 130, 140, the wafers 10, 20 are cooled down in the blown-out state.

In a subsequent step 150, the mold substrate 10 is at least partially or fully removed from the molded cover substrate 40, i.e. from the spring structure 40, wherein the molded cover substrate 40 now forms the spring structure 40. The cover substrate 40 comprises a single homogenous glass material to form the spring structure 40 with the surrounding glass bulge 42 from this single homogeneous glass material, wherein the surrounding glass bulge 42 is arranged as a spring element between a (surrounding) outer area 44 and an inner area 46, surrounded by the glass bulge 42, of the cover substrate 40.

According to an embodiment, the flow diagram 100-1 of the method 100 may further comprise the step 142 of cooling the mold substrate 10 and the molded cover substrate 20′, wherein, in step 150, the mold substrate 10 is subsequently at least partially or fully removed by means of an etching process, e.g. a silicon or semiconductor etching process of the silicon or semiconductor material of the mold substrate.

Since, for example, the cover substrate 20 comprises a (single) homogenous glass material or consists thereof, the spring structure is also configured integrally from the homogenous glass material.

In an (optional) subsequent step, the process flow 100-1 of the method 100 may further include dicing the molded cover substrate 40 to obtain diced spring structures 40. Dicing the cover substrate 40 may be carried out by sawing or laser separation. For example, sensors, such as capacitive sensors, may be built with the diced spring structures (glass spring structures). Dicing may also be carried out after a plurality of sensors has been built, e.g. on the wafer level.

FIG. 3 now shows an exemplary principle of the flow diagram 100-2 of the inventive manufacturing method 100 according to a further embodiment for providing a vertically offset (in the direction of the bulge) inner area of the spring structure.

In the further embodiment of the flow diagram 100-2 of the manufacturing method 100 shown in FIG. 3, the method steps shown on the basis of FIGS. 1 and 2 are essentially carried out again, wherein subsequently, above all, the additions and changes of the manufacturing method 100 described above are illustrated. Identical and functionally identical and effectively identical elements, objects, functional blocks, and/or method steps are provided in the different drawings with the same reference numerals so that the description of these elements, objects, functional blocks, and/or method steps (with the same reference numerals) illustrated in different embodiments is interchangeable or can be applied to each other.

According to an embodiment of the flow diagram 100-2 of the method 100 of FIG. 3, a vertical offset, i.e. a height of the Δz, can be created in the direction of the bulge 42 (in the bulge direction) between the inner area 46 and the outer area 44 of the spring structure 40 so that the inner area 46 is offset vertically in the bulging direction with respect to the outer area 44 of the spring structure. To this end, e.g. the following additional steps (after manufacturing the glass bulge 42 of the spring structure 40) may be carried out.

With respect to the edge area “R” illustrated in the flow diagram 100-2 of the method 100 of FIG. 3, it is to be noted that this area, together with the further bulge 48 formed therein, is provided only to facilitate a final dicing process of the mold substrate 40, or a sensor element manufactured therewith.

In the preparation of the actual manufacturing process, in step 110 (with the sub-steps 112, 114, 116), the mold substrate 10, e.g. a silicon mold substrate, may be provided with single-sided cavities 12 (=recesses or indentations) and may be provided together with the cover substrate (glass wafer) 20.

In the optional step (sub-step) 112, e.g. the mold substrate 10 is provided. After a photolithographic surface treatment of the mold substrate 10, in an optional step (sub-step) 114, the mold substrate 10 is now structured, i.e. provided with the surrounding continuous recess 30. In an optional step 116, the cover substrate 20 is provided, wherein the cover substrate 20 comprises a glass material or consists thereof.

In step 120, the glass wafer 20 is aligned with respect to the mold substrate 10 and is anodically bonded in a defined atmosphere, e.g. to enclose a (defined) gas pressure in the (at least one) surrounding cavity 32. According to an embodiment of the flow diagram 100-2 of the method 100, the cover substrate 20 and/or the mold substrate 10 are configured to form the (at least one) closed surrounding (continuous) cavity 32 between the cover substrate 20 and the mold substrate 10. In step 120, the mold substrate 10 and the cover substrate 20 are provided as a bonded substrate stack 10, 20. Finally, in a further optional intermediate step 122, the cover substrate (the glass wafer) may be ground down to a desired thickness, e.g. by means of a CMP process.

In (subsequent) step 130, the cover substrate 20 and the mold substrate 10 are now tempered, i.e. subjected to temperature treatment, or heated, to decrease the viscosity of the glass material of the cover substrate 20. Furthermore, in step 140, an overpressure is provided in the (at least one) closed surrounding cavity 32 with respect to the ambient atmosphere to cause, based on the decreased viscosity of the glass material of the cover substrate 20 and the overpressure in the (at least one) closed cavity 32 with respect to the ambient atmosphere, a defined bulging, e.g. a blow-out or deformation, of the glass material of the cover substrate 20 starting from the closed surrounding cavity/cavities 32.

In a subsequent step 144, according to the flow diagram 100-2 of the method 100, a carrier structure 14, e.g. a cap substrate or carrier substrate, is now attached (bonded) to the molded cover substrate 40 so that the substrate stack 1020 is firmly connected to the carrier substrate 40.

In a step 146 of the flow diagram 100-2 of the manufacturing method 100, the mold substrate 10 is now at least partially (planarly) removed to expose or open the surrounding continuous channel 30 in the mold substrate 10, i.e. to open the trenches 30. In this case, e.g. the semiconductor material of the mold substrate 10 may remain with a layer thickness 50 to 100 μm.

Now, for example, the carrier substrate 14 is attached to the outer area 44 of the spring structure 40 such that the inner area 46 remains (vertically) deflectable. Furthermore, the carrier substrate 14 may be configured and attached to the outer area 44 of the spring structure 40 such that a hermetically closed cavity 34 is formed between the spring structure and the carrier substrate 14, wherein the inner area 46 remains (vertically) deflectable.

In a step 148 of the flow diagram 100-2 of the manufacturing method 100 for providing a vertically offset (in the direction of the bulge 42) inner area 46 of the spring structure 40 according to the embodiment of FIG. 3, the cover substrate 40 provided with the glass bulge 42 is tempered (again) (post-tempered) to decrease the viscosity of the glass material of the cover substrate 40 provided with the bulge 42. Since the glass bulge 42 comprises a thickness that is significantly smaller (≤10%) than the inner and outer areas 46, 44 of the spring structure 40, little heat input is already sufficient to sufficiently decrease the viscosity of the glass material of the glass bulge 42.

Subsequently, a force “F” is applied to the inner area 46 of the spring structure 40 in the direction of the bulge 42 (in the bulging direction) to create the vertical offset Δz (height offset) between the outer area 44 and the inner area 46 of the spring structure 40 in the direction of the bulge (in the bulging direction). As soon as the increased temperature has decreased back to the normal range, the offset between the outer area 44 and the inner area 46 of the spring structure 40 remains.

Applying the force F onto the inner area 46 of the spring structure 40 in the direction of the bulge 42 may be carried out by aligning the substrate stack 10, 20, which is fixed to the carrier substrate, such that gravity, i.e. the weight of the inner area 46 of the spring structure 40, deforms the surrounding glass bulge 42 (during post-tempering) and the lateral offset Δz takes place in the direction of the glass bulge 42 of the inner area 46 of the spring structure 40.

Alternatively, the carrier substrate 14 may be configured such that the main surface area, provided with the bulge 42, of the cover substrate 20 is hermetically (gas-tight) surrounded or closed by the carrier substrate 14 so that, by setting a negative pressure in the volume 34 formed by the carrier substrate 14 and the cover substrate 20 (with respect to the surrounding pressure), the inner area 46 of the spring structure 40 is offset in the direction of the glass bulge 42 (in post-tempering).

In the case of an exemplary thickness of the cover substrate 20 of 80-150 μm, e.g. approximately 100 or 120 μm, the height offset Δz (FIG. 3) may be in a range of between 20-60 μm, e.g. approximately at 40 μm.

The two approaches for manufacturing the offset of the inner area with respect to the outer area of the spring structure illustrated above may also be applied in combination.

Furthermore, there is the option to perform step 150 with the above-illustrated step 146 so that step 148 of post-tempering and manufacturing the offset Δz is carried out when the mold substrate 10 is already (at least partially or fully) removed from the molded cover substrate 20.

As illustrated in the flow diagram 100-2 of the manufacturing method 100, an additional bulge 48 may be provided in the cover substrate. This additional further bulge 48 may later be used for simplified dicing (for exposing the lateral electrical connection structures of the spring structure).

Performing the glass flow process 130, 140 and post-tempering 146 may therefore be carried out in a pressure-controlled furnace 45, for example.

According to the embodiment of the method 100, step 150 of removing the (remaining) mold substrate 10 may be carried out by means of an etching process, i.e. the silicon or semiconductor material of the mold substrate 10 may be at least partially or fully removed with a silicon or semiconductor etching process, e.g. in hot potassium hydroxide solution. Removing 150 may also mean separating the semiconductor material of the mold substrate by means of an etching process (silicon or semiconductor etching process of the silicon or semiconductor material) from the molded cover substrate 40.

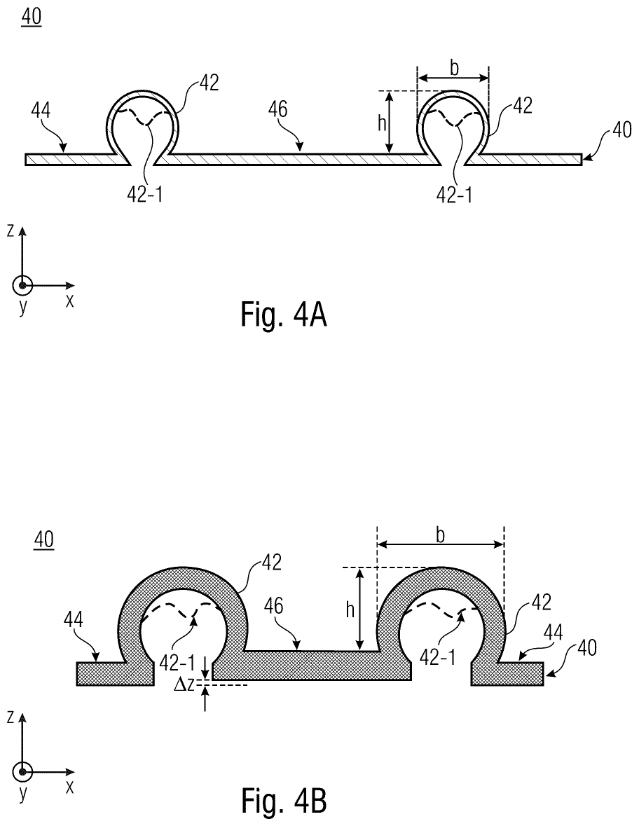

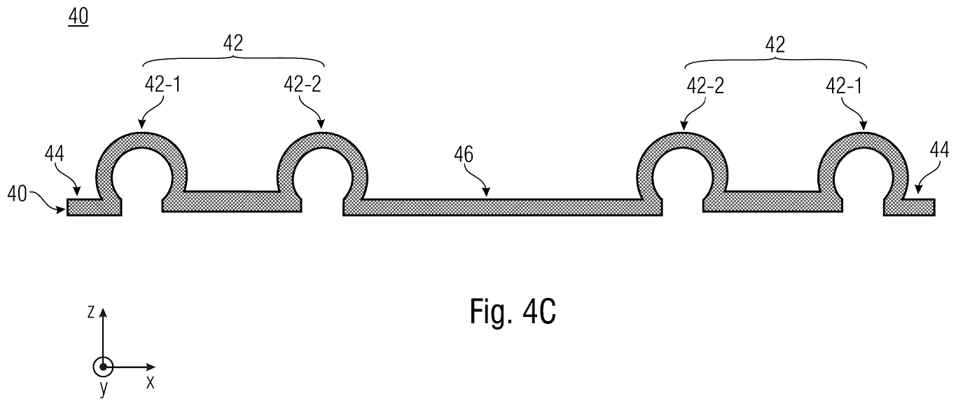

FIGS. 4a-c now show exemplary embodiments of the spring structure (glass spring structure) according to an embodiment.

According to the embodiment of FIGS. 4a-c, the spring structure 40 comprises a (molded) glass substrate, wherein the molded glass substrate comprises a surrounding (continuous) glass bulge 42 between an outer area 44 and a deflectable inner area 46, i.e. deflectable “relative” to the outer area 44, of the glass substrate 40. In this case, the surrounding glass bulge 42 is operable as a spring element 42 between the outer area 44 and the inner area 46.

According to the embodiment, the inner area 46 is deflectable, e.g. vertically deflectable, with respect to the outer area 44 by means of the spring element 42 configured as a surrounding glass bulge.

According to an embodiment, the cover substrate 40, and therefore the spring structure 40, comprises a single homogenous glass material to form the spring structure (glass spring structure) 40 from this single homogenous glass material.

According to an embodiment, the surrounding glass bulge 42 comprises a cross section in the shape of a superimposed circular segment (omega shape). The vertical cross section of the glass bulge 42 comprises, e.g., (approximately) a torus with a cross section in the form of a superimposed three-quartered circle or a superimposed circular segment.

According to an embodiment, the surrounding glass bulge 42 may also comprise a (surrounding) depression (indentation) 42-1.

According to an embodiment, the surrounding glass bulge 42 is circularly surrounding, elliptically surrounding, or ovally surrounding.

According to an embodiment, the surrounding glass bulge 42 comprises a constant width b and height h to form a symmetrically surrounding glass bulge 42.

According to a further embodiment, the width b and the height h of the surrounding glass bulge 42 vary to form an asymmetrically surrounding glass bulge 42. Using the shape and size of the glass bulge, the resulting spring stiffness (elasticity) of the spring element 42 of the spring structure 40 may be set.

According to a further embodiment, the spring structure 40 may comprise a plurality of surrounding glass bulges 42 (in the cover substrate 20) that are arranged concentrically and/or in parallel. In the case of three or more glass bulges 42, the glass bulges 42 are each arranged with a same distance between adjacent bulges 42. In the case of circularly surrounding bulges 42 of the glass material in the cover substrate 40, the plurality of surrounding glass bulges is arranged concentrically (and in parallel) with respect to each other, for example. In the case of elliptically surrounding or ovally surrounding glass bulges 42 in the cover substrate, the plurality of surrounding glass bulges is arranged in parallel to each other.

In the embodiment of FIG. 4a, the outer area 44 and the inner area 46 of the spring structure are arranged in a common (lateral) plane.

In the embodiment of FIG. 4b, the outer area 44 and the inner area 46 of the spring structure are arranged with a different vertical offset Δz, i.e. a vertical offset (height offset) is configured between the outer area 44 and the inner area 46 of the spring structure 40 in the direction of the bulge (in the bulging direction).

In the embodiment of FIG. 4c, a cover substrate 40 provided with a plurality of surrounding glass bulges 42 (42-1, 42-2) that are arranged concentrically or parallel to each other is to be obtained. A plurality of (adjacent) surrounding glass bulges 42-1, 42-2 in the cover substrate 40 may be considered to be a serial array of spring elements 42-1, 42-2 for setting the desired spring constant of the resulting spring element 42 (42-1+42-2) of the spring structure 40. Furthermore, the resulting (vertical) deflection range of the resulting spring element 42 (42-1+42-2) may be increased.

In the following, a schematic flow diagram of the inventive method 200 for manufacturing the capacitive pressure sensor 50 is now described on the basis of FIG. 5, as an example.

First, in a step 210 of the manufacturing method 200, the method 100 for manufacturing a spring structure 40 is performed, as exemplarily described on the basis of the schematic flow diagram of the inventive manufacturing method 100 in FIG. 1 and on the basis of the principal flow diagrams 100-1, 100-2 of the inventive manufacturing method 100 for manufacturing a spring structure in FIGS. 2 and 3.

In a step 220 of the manufacturing method 200, the outer area of the spring structure is connected to a base substrate to form a hermetically closed cavity between the spring structure and the base substrate. In this case, the inner area of the spring structure and the opposite outer area of the base substrate are (vertically) spaced apart so that the inner area of the spring structure is deflectable within the cavity with respect to the base substrate. In this case, a capacitive structure is arranged at the base substrate of the deflectable inner area of the spring structure, wherein the capacitive structure is configured to provide, based on a (vertical) deflection Δz of the inner area 46 of the spring structure 40, a capacitive change ΔC depending on the (vertical) deflection Δz.

According to an embodiment, the cover substrate 40 and the base substrate 60 are hermetically connected or joined, wherein this may be achieved by means of an anodic bonding process or another joining process, for example.

The inner area of the spring structure and the opposite surface area of the base substrate are (vertically) spaced apart from each other such that the inner area of the spring structure is deflectable within the cavity with respect to the base substrate. The (vertical) distance of the inner area of the spring structure with respect to the opposite surface area of the base substrate may be achieved in different ways.

According to an embodiment, the base substrate may comprise a recess to form the hermetically closed cavity between the spring structure and the base substrate, wherein the recess of the base substrate is part of the cavity and the inner area of the spring structure is deflectable with respect to the recess.

According to a further embodiment, the inner area of the spring structure may be arranged so as to be vertically offset with respect to the outer area of the spring structure (in the direction of the bulge) so that the inner area of the spring structure is deflectable within the cavity with respect to the base substrate.

Furthermore, according to an embodiment (in step 220 of connecting), a surrounding spacer (spacing element) may be arranged laterally outside of the (outermost) bulge between the outer area of the spring structure and the base substrate to provide the vertical distance (freewheel or offset).

According to an embodiment, the above measures for providing the vertical distance (freewheel or offset) between the outer area 44 of the spring structure 40 and the base substrate 60 may be provided individually. Furthermore, according to a further embodiment, the above measures for providing the vertical distance (freewheel or offset) between the outer area of the spring structure and the base substrate may also be combined. According to an embodiment, two or all of the above measures for setting the distance may be combined to provide the vertical distance (freewheel or offset) between the outer area of the spring structure and the base substrate.

According to a further embodiment of the method 200, the capacitive structure may be arranged in the form of capacitive metallization structures at the base substrate opposite the deflectable inner area of the spring structure, or the capacitive structure may be arranged in the form of highly doped doping areas in the base substrate, comprising a semiconductor material, opposite the deflectable inner area of the spring structure.

According to a further embodiment, the method 200 may further comprise a step of depositing a metallization as a capacitively effective structure on the main surface area, facing away from the glass bulge, of the inner area (intermediate area) of the spring structure.

According to a further embodiment, the method 200 may further include a step of forming (or configuring) interdigital structures on the main surface area, facing away from the glass bulge, of the inner area (intermediate area) of the spring structure, wherein a corresponding capacitive interdigital structure is arranged at the base substrate opposite the (deflectable) inner area of the spring structure.

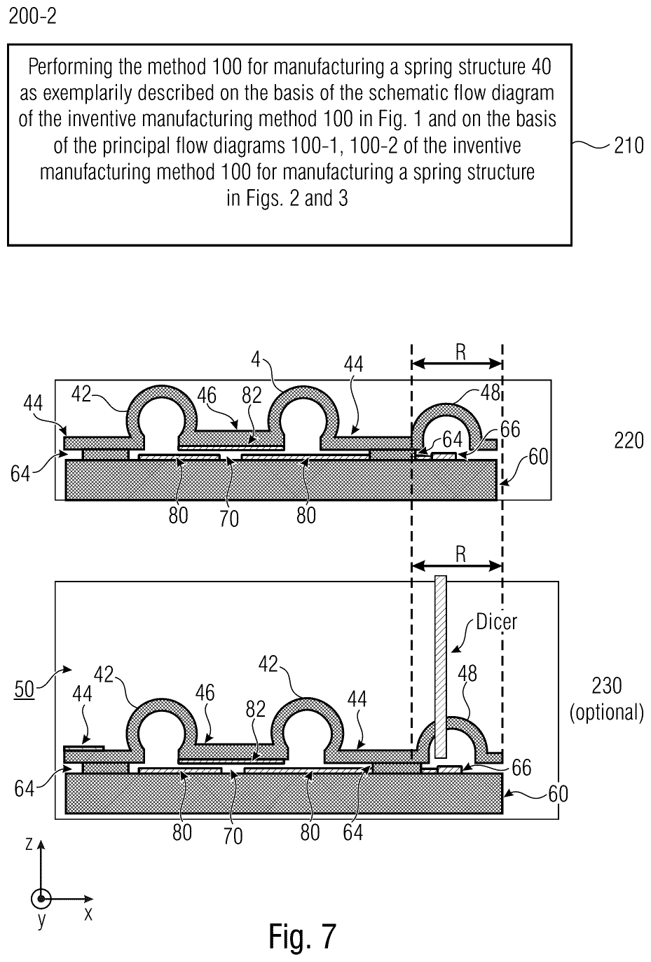

FIG. 6 now shows an exemplarily principal flow diagram 200-1 of the inventive manufacturing method 200 for a capacitive pressure sensor (e.g. an absolute pressure sensor) 50 according to a further embodiment.

First, in step 210 of the manufacturing method 200, the method 100 for manufacturing a spring structure 40 is carried out, as exemplarily described on the basis of the schematic flow diagrams of the inventive manufacturing method 100 in FIG. 1 and on the basis of the principal flow diagrams 100-1, 100-2 of the inventive manufacturing method 100 for manufacturing a spring structure in FIGS. 2 and 3.

In step 220 of the manufacturing method 200, the outer area 44 of the spring structure 40 is connected to a base substrate 60 to form a hermetically closed cavity 70 between the spring structure 40 and the base substrate 60. In this case, the inner area 46 of the spring structure 40 and the opposite surface area 60-1 of the base structure 60 are (vertically) spaced apart so that the inner area 46 of the spring structure 40 is deflectable within the cavity 70 with respect to the base substrate 60.

In this case, a capacitive structure 80 is arranged at the base substrate 60 opposite the deflectable inner area 46 of the spring structure 40, wherein the capacitive structure 80 is configured to provide, on the basis of a (vertical) deflection Δz of the inner area 46 of the spring structure 40, a capacitive change ΔC that is dependent on the (vertical) deflection Δz.

According to an embodiment, the cover substrate 40 and the base substrate 60 are hermetically connected or joined, wherein this may be achieved with an anodic bonding process or another joining process, for example.

The inner area (“boss”) 46 of the spring structure 40, which is effective as a pressure measuring surface, and the opposite surface area 60-1 of the base substrate 60 are (vertically) spaced apart so that the inner area 46 of the spring structure 40 is deflectable within the cavity 70 with respect to the base substrate 60. The (vertical) distance of the inner area 46 of the spring structure 40 to the opposite surface area 60-1 of the base substrate 60 may be achieved in different ways.

According to an embodiment, the base substrate 60 may comprise a recess 62 to form the hermetically closed cavity 70 between the spring structure 40 and the base substrate 60, wherein the recess 62 of the base substrate 60 is part of the cavity 70, and the inner area 46 of the spring structure 40 is deflectable with respect to the recess 62.

According to a further embodiment (cf. the exemplary process flow 200-2 of FIG. 7), the inner area 46 of the spring structure 40 may be arranged so as to be vertically offset with respect to the outer area 44 of the spring structure 40 (in the direction of the bulge 42) so that the inner area 46 of the spring structure 40 is deflectable within the cavity 70 with respect to the base substrate 60.

Furthermore, according to an embodiment (in step 220 of connecting), a surrounding spacer 64 (cf. the exemplary process flow 200-3 of FIG. 7) may be arranged outside of the (outermost) bulge 42 between the outer area 44 and the spring structure 40 and the base substrate 60 to provide the vertical distance (freewheel or offset) in the hermetically closed cavity 70. Then, e.g., the recess 62 is no longer required in the base substrate 60 to create the hermetically closed cavity 70.

According to an embodiment, the above measures for providing the vertical distance (freewheel or offset) between the outer area 44 of the spring structure 40 and the base substrate 60 may be provided individually. Furthermore, according to an embodiment, the above measures for providing the vertical distance (freewheel or offset) between the outer area 44 of the spring structure 40 and the base substrate 60 may also be combined. According to an embodiment, two or even all of the above measures for setting the distance may be combined to provide the vertical distance (freewheel or offset) between the outer area 44 of the spring structure 40 and the base substrate 60.

According to a further embodiment of the method 200, the capacitive structure 80 may be arranged in the form of capacitive metallization structures at the base substrate 60 opposite the deflectable inner area 46 of the spring structure 40, or the capacitive structure may be arranged in the form of highly doped doping areas in the base substrate 60, comprising a semiconductor material, opposite the deflectable inner area 46 of the spring structure 40.

According to a further embodiment, the method 200 may further include a step of depositing a metallization 82 as a capacitively effective structure on the main surface area, facing away from the glass bulge, of the inner area 46 (the intermediate area or the pressure measuring surface) of the spring structure 40.

According to a further embodiment, the method 200 may further include a step of forming (configuring) interdigital structures on the main surface area, facing away from the glass bulge 42, of the inner area 46 (intermediate area) of the spring structure, wherein a corresponding capacitive interdigital structure 80 is then arranged at the base substrate 60 opposite the (deflectable) inner area 46 of the spring structure 40.

For example, the capacitive structure 80 may be arranged in the form of (separated) capacitive metallization structures at the base substrate 60 opposite the deflectable inner area 46 of the spring structure 40. Thus, electrical contacting to the cover substrate 40 or the deflectable inner area 46 of the spring structure 40 is not required.

FIG. 7 now shows an exemplary principal flow diagram 200-2 of the inventive manufacturing method 200 for a capacitive pressure sensor (e.g. an absolute pressure sensor) 50 according to a further embodiment.

In the further embodiment of the flow diagram 200-2 of the manufacturing method 200 shown in FIG. 7, essentially, the method steps shown on the basis of FIGS. 5 and 6 are performed again, wherein all identical and functionally and effectively identical elements, objects, functional blocks, and/or method steps are provided in different drawings with the same reference numerals so that the description of these elements, objects, functional blocks and/or method steps (with the same reference numerals) illustrated in the different embodiments are interchangeable or may be applied to one another.

First, in step 210 of the manufacturing method 200, the method 100 for manufacturing a spring structure 40 is carried out, as exemplarily described on the basis of the schematic flow diagram of the inventive manufacturing method 100 in FIG. 1 and on the basis of the principal flow diagrams 100-1, 100-2 of the manufacturing method 100 for manufacturing a spring structure in FIGS. 2 and 3.

In step 220 of the manufacturing method 200, the outer area 44 of the spring structure 40 is connected to a base substrate 60 to form a hermetically closed cavity 70 between the spring structure 40 and the base substrate 60. In this case, the inner area 46 of the spring structure 40 and the opposite surface area 60-1 of the base substrate 60 are (vertically) spaced apart so that the inner area 46 of the spring structure 40 is deflectable within the cavity 70 with respect to the base substrate 60.

In this case, a capacitive structure 80 is arranged at the base substrate 60 opposite the deflectable inner area 46 of the spring structure 40, wherein the capacitive structure 80 is configured to provide, based on a (vertical) deflection Δz of the inner area 46 of the spring structure 40, a capacitive change ΔC that is dependent on the (vertical) deflection Δz.

According to an embodiment, the cover substrate 40 and the base substrate 60 are hermetically connected or joined, wherein this may be achieved with an anodic bonding process or another joining process, for example.

The inner area (“boss”) 46 of the spring structure 40, effective as a pressure measuring face, and the opposite surface area 60-1 of the base substrate 60 are (vertically) spaced apart such that the inner area 46 of the spring structure 40 is deflectable within the cavity 70 with respect to the base substrate 60. The (vertical) distance of the inner area 46 of the spring structure 40 with respect to the opposite surface area 60-1 of the base substrate 60 may be achieved in different ways.

According to the illustrated embodiment of FIG. 7, the inner area 46 of the spring structure may be arranged so as to be offset vertically with respect to the outer area 44 of the spring structure 40 (in the direction of the bulge 42) so that the inner area 46 of the spring structure 40 is deflectable within the cavity 70 with respect to the base substrate 60.

Furthermore, according to the illustrated embodiment of FIG. 7, (in step 220 of connecting), alternatively or additionally to the vertical offset Δz, a spacer 64 may be arranged outside of the (outermost) bulge 42 between the outer area 44 of the spring structure 40 and the base substrate 60 (cf. the exemplary process flow 200-3 of FIG. 7) to provide the vertical distance (freewheel or offset) in the hermetically closed cavity 70. Then, e.g., the recess 62 is no longer required in the base substrate 60 to create the hermetically closed cavity 70. The spacer 64 may further be provided to enable lead-out of contacts or contact terminal faces 66, e.g., electrically coupled (connected) to the capacitive structure 80 at the base substrate 60, for example.

According to an embodiment (cf. the exemplary process for 200-2 of FIG. 7), the base substrate 60 may comprise a recess 62 to form the hermetically closed cavity 70 between the spring structure 40 and the base substrate 60, wherein the recess 62 of the base substrate 60 is part of the cavity 70, and the inner area 46 of the spring structure 40 is deflectable with respect to the recess 62.

According to an embodiment, the above measures for providing a vertical distance (freewheel or offset) between the outer area 44 and the spring structure 40 and the base substrate 60 may each be provided individually. Furthermore, according to an embodiment, the above measures fort providing the vertical distance (freewheel or offset) between the outer area 44 of the spring structure 40 and the base substrate 60 may also be combined.

According to an embodiment, two or even all of the above measures for setting the distance may be combined to provide the vertical distance (freewheel or offset) between the outer area 44 of the spring structure 40 and the base substrate 60.

According to a further embodiment of the method 200, the capacitive structure 80 may be arranged in the form of capacitive metallization structures at the base substrate 60 opposite the deflectable inner area 46 of the spring structure 40, or the capacitive structure may be arranged in the form of highly doped doping areas in the base substrate 60, comprising a semiconductor material, opposite the deflectable inner area 46 of the spring structure 40.

According to a further embodiment, the method 200 may further include the step of depositing a metallization 82 as a capacitively effective structure on the main surface area, facing away from the glass bulge, of the inner area 46 (the intermediate area or the pressure measuring surface) of the spring structure 40.

According to a further embodiment, the method 200 may further include a step of forming (configuring) interdigital structures 82 on the main surface area, facing away from the glass bulge 42, of the inner area 46 (intermediate area) of the spring structure, wherein a corresponding capacitive interdigital structure 80 is then arranged at the base substrate 60 opposite the (deflectable) inner area 46 of the spring structure 40.

According to a further embodiment, the method 200 may further include an optional step 230 of dicing the cover substrate 40 or the capacitive sensor element 50. With respect to the edge area “R” illustrated in the flow diagram 200-2 of the method 200 of FIG. 2, it is to be noted that this area together with the further bulge 48 formed therein is provided to facilitate a final dicing process 230 of the molded cover substrate 40 or of a sensor element manufactured therewith. Dicing 230 the cover substrate 40 or the capacitive sensor element 50 may be carried out by sawing or laser separation.

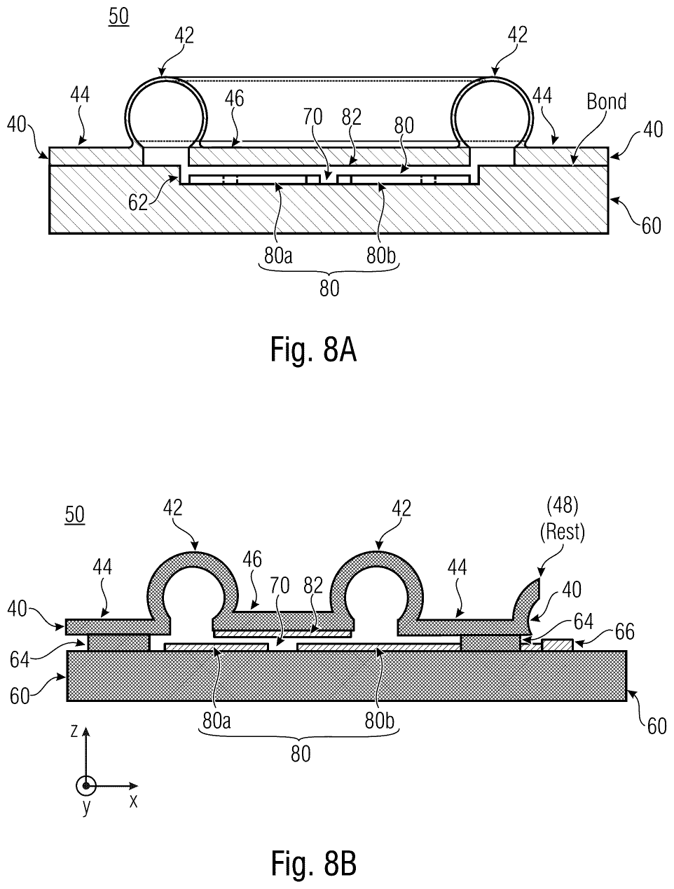

FIGS. 8a-b now show exemplary embodiments of a capacitive pressure sensor 50 (e.g. an absolute pressure sensor) according to further embodiments.

According to the embodiment of FIGS. 8a-b, the capacitive pressure sensor 50 comprises the exemplarily embodiments of the spring structure (glass spring structure) 40 according to an embodiment described on the basis of FIGS. 4a-b. In this case, a capacitive structure 80 is arranged at the base substrate 60 opposite the deflectable inner area 46 of the spring structure 40, wherein the capacitive structure 80 is configured to provide, on the basis of a (vertical) deflection Δz of the inner area 46 of the spring structure 40, a capacitive change ΔC that is dependent on the (vertical) deflection Δz. According to the embodiment of the capacitive pressure sensor, the cover substrate 40 and the base substrate 60 are hermetically connected or joint (bonded).

The inner area (“boss”) 46 of the spring structure 46, effective as a pressure measuring face, and the opposite surface area 60-1 of the base substrate 60 are (vertically) spaced apart so that the inner area 46 of the spring structure is deflectable within the cavity 70 with respect to the base substrate 60. The (vertical) distance of the inner area 46 of the spring structure 40 with respect to the opposite surface area 60-1 of the base structure 60 may be achieved in different ways.

According to the illustrated embodiment of FIG. 8a, the base structure 60 may comprise a recess 62 to form the hermetically closed cavity 72 between the spring structure 40 and the base substrate 60, wherein the recess 62 of the base substrate 60 is part of the cavity 70, as the inner area 46 of the spring structure 40 is deflectable with respect to the recess 62.

According to the illustrated embodiment of FIG. 8b, a surrounding spacer (glass frit) 64 may be arranged outside of the (outermost) bulge 42 between the outer area 44 of the spring structure 40 and the base substrate 60 to provide the vertical distance (freewheel or offset) in the hermetically closed cavity 70. Then, e.g., the recess 62 is no longer required in the base substrate 60 to create the hermetically closed cavity. The spacer 64 may further be provided to enable lead-out of contacts or contact terminal faces 66 that are electrically coupled (connected) to the capacitive structure 80 at the base substrate 60, for example.

According to the illustrated embodiment of FIG. 8b, the inner area 64 of the spring structure may arranged so as to be offset vertically with respect to the outer area 44 of the spring structure 40 (in the direction of the bulge 42) so that the inner area 46 of the spring structure is deflectable within the cavity 70 with respect to the base substrate 60.

According to an embodiment, the above measures for providing the vertical distance (freewheel or offset) between the outer area 44 of the spring structure 40 at the base substrate 60 may each be provided individually. Furthermore, according to an embodiment, the above measures for providing the vertical distance (freewheel or offset) between the outer area 44 of the spring structure 40 at the base substrate 60 may also be combined. According to an embodiment, two or even all of the above measures for setting the distance may be combined to provide the vertical distance (freewheel or offset) between the outer area 44 of the spring structure 40 at the base substrate 60.s

According to the illustrated embodiments of FIGS. 8a-b, the capacitive structure 80 may be arranged in the form of (separated) capacitive metallization structures 80a, 80b at the base substrate 60 opposite the deflectable inner area 46 of the spring structure 40, or the capacitive structure may be arranged in the form of (separated) highly doped doping areas 80a, 80b in the base substrate 60, comprising the semiconductor material, opposite the deflectable inner area 46 of the spring structure 40. Thus, electrical contacting with respect to the cover substrate 40 or with respect to the deflectable inner area 46 of the spring structure 40 is no longer required.

According to the illustrated embodiment FIGS. 8a-b, a metallization 82 may further be arranged as a capacitively effective structure on the main surface area, facing away from the glass bulge, of the inner area 46 (intermediate area or the pressure measuring phase) of the spring structure 40 (in addition to the capacitive structure 80 at the base substrate 60).

According to the illustrated embodiment of FIGS. 8a-b, the capacitive structure 82 may be arranged as interdigital structures on the main surface area, facing away from the glass bulge 42, of the inner area 64 (intermediate area) of the spring structure 40, wherein a corresponding capacitive interdigital structure 80 may then be arranged at the base substrate 60 opposite the (deflectable) inner area 46 of the spring structure 40.

According to the illustrated embodiment of the capacitive sensor 50 of FIGS. 8a-b, for example, the capacitive structure 80 is configured at the base substrate 60 as two plan-parallel (divided or separated) capacitor plates or capacitor faces 80a, 80b. Due to the pressure-caused or pressure-dependent vertical deflection of the inner area 46 of the spring structure 40, the electrostatic coupling of the plan-parallel capacitor plates 80a, 80b of the capacitor structure 80 at the base substrate 60 changes. Thus, the capacitive structure 80 at the base substrate 80 is configured to provide, based on a (vertical) deflection Δz of the inner area 46 of the spring structure 40, a capacitive change ΔC that is dependent on the (vertical) deflection Δz.

Thus, if the vertical distance between the inner area 46 of the spring structure 40 and the capacitive structure 80 at the base substrate 60 changes, the electrostatic (capacitive) coupling between the plan-parallel capacitor plates 80a, 80b of the capacitive structure 80 changes as well. Furthermore (in addition to the capacitive structure 80 at the base substrate 60), a metallization 82 may be arranged as a capacitively effective structure on the main surface area, facing away from the glass bulge, of the inner area 46 (the intermediate area or the pressure measuring phase) of the spring structure 40. The metallization 82 may be configured as a “floating” (non-contacted-potential-free) metallization. Due to the metallization 82, the electrostatic (capacitive) coupling between the plan-parallel capacitor plates 80a, 80b of the capacitive structure 80 may be (significantly) increased and the effect of the (vertical) deflection of the inner area 46 of the spring structure 40 with respect to the capacitive change ΔC that is dependent on the (vertical) deflection may be increased.

According to an embodiment, the capacitive structure 80 at the base substrate 60 and the opposite further capacitive structure 82 at the inner area 46 of the spring structure 40 may be configured as opposite capacitor plates. On the inner side of the glass membrane 40, the electrode phases may be coated with metal. This face may then be used as one of the two capacitor plates when structuring the capacitive pressure sensor with plane plate capacitors.

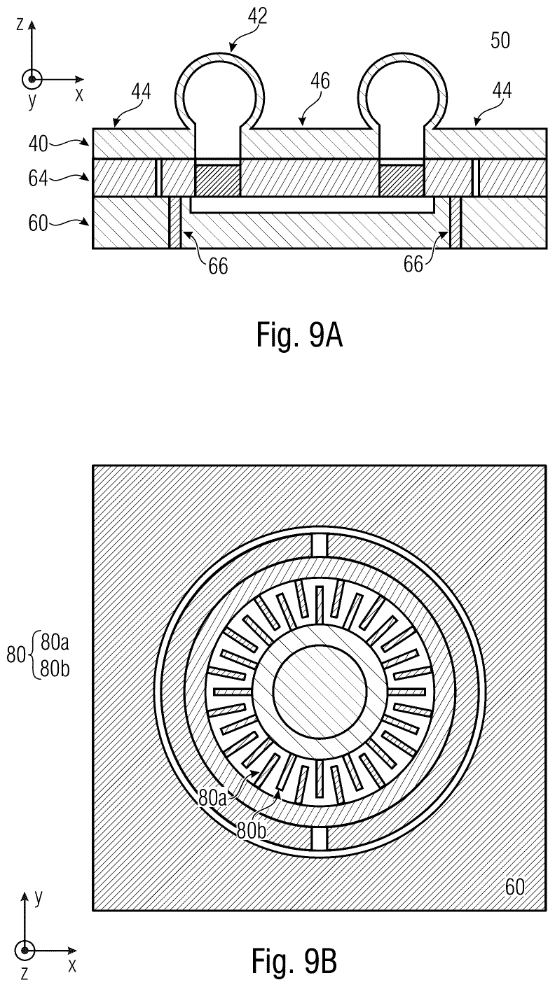

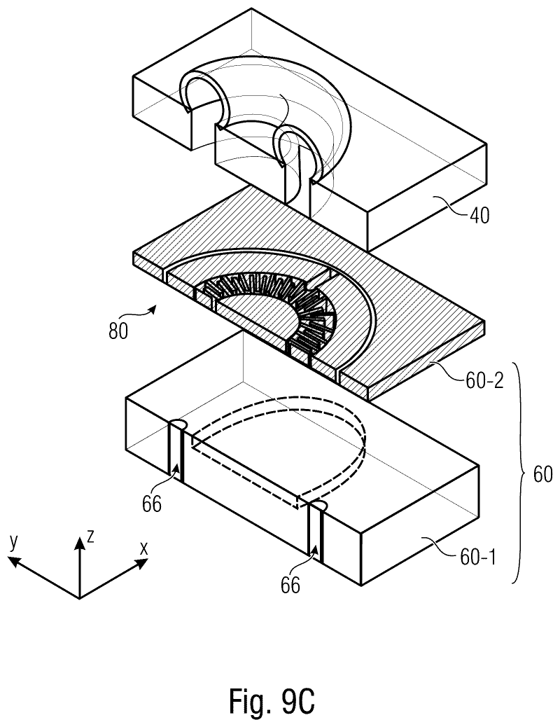

FIGS. 9a-c now show exemplary embodiments of the capacitive structure 80 at the base substrate 60 and/or the capacitive structure 82 of the spring structure 40 of a capacitive pressure sensor 50 (e.g. an absolute pressure sensor) according to further embodiments.

As exemplarily illustrated in FIGS. 9a-c, the capacitive pressure sensor 50 is configured according to the exemplary embodiments of the capacitive pressure sensor 50 described on the basis of FIGS. 8a-b.

According to the illustrated embodiment of FIGS. 9a-c, the further capacitive structure 82 may be configured as a metallization or an interdigital structure 82 on the main surface area, facing away from the glass bulge 42 of the inner area 46 (intermediate area) of the spring structure 40. Furthermore, the capacitive structure 80 at the base substrate may comprise a capacitive interdigital structure 80 with the two interdigital finger structures 80a, 80b at the base substrate 60 opposite the (deflectable) inner area 46 of the spring structure 40 or opposite the metallization or interdigital structure 82 at the (deflectable) inner area 46 of the spring structure 40.

FIG. 9c illustrates the base structure 60 as a combination of two layer planes 60-1, 60-2 to clearly illustrate the capacitive interdigital structure and the contact structures (through-contacts or vias 66) through the base substrate 60.

In contrast to the parallel plate capacitor, this measurement arrangement with interdigital structures also enables large membrane strokes so that an even (significantly) larger measuring range can be realized for the pressure sensor 50 with the same sensitivity.

By configuring the capacitive structure as intermeshing interdigital structures, the resulting capacity is changed through the varying overlap area of the (lateral) opposite interdigital structures. In such an interdigital arrangement, a relatively large vertical deflection (stroke) of the inner area 46 of the spring structure 40 with respect to the base substrate 60 may be captured due to the (vertical) immersion of the intermeshing interdigital structures. As a result, a very linear relationship between the (vertical) deflection of the inner area 46 of the spring structure 40 and the (readable) capacitive change of the interdigital structure may be obtained with relatively high capacitive values.

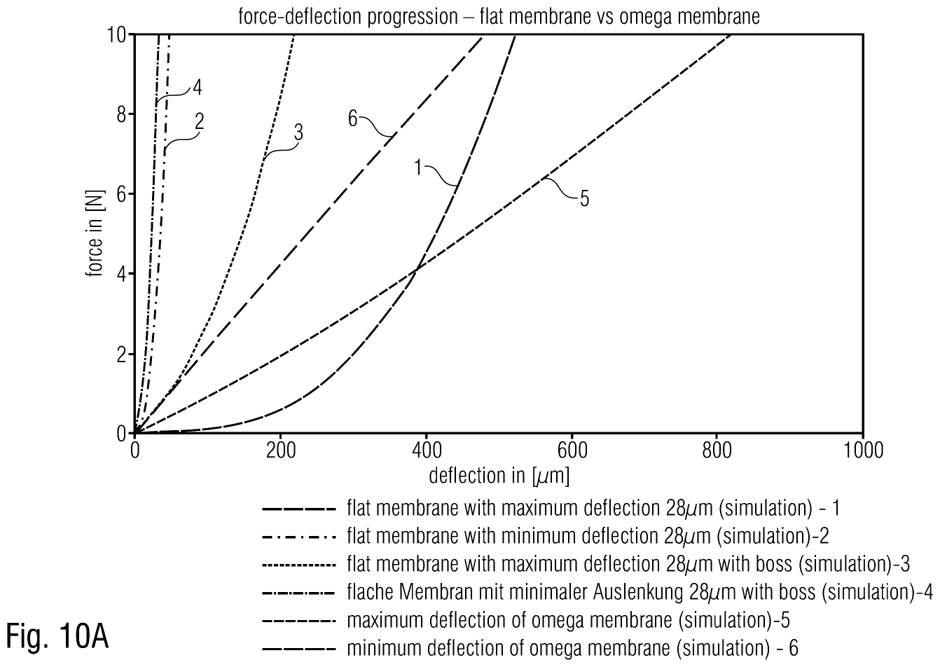

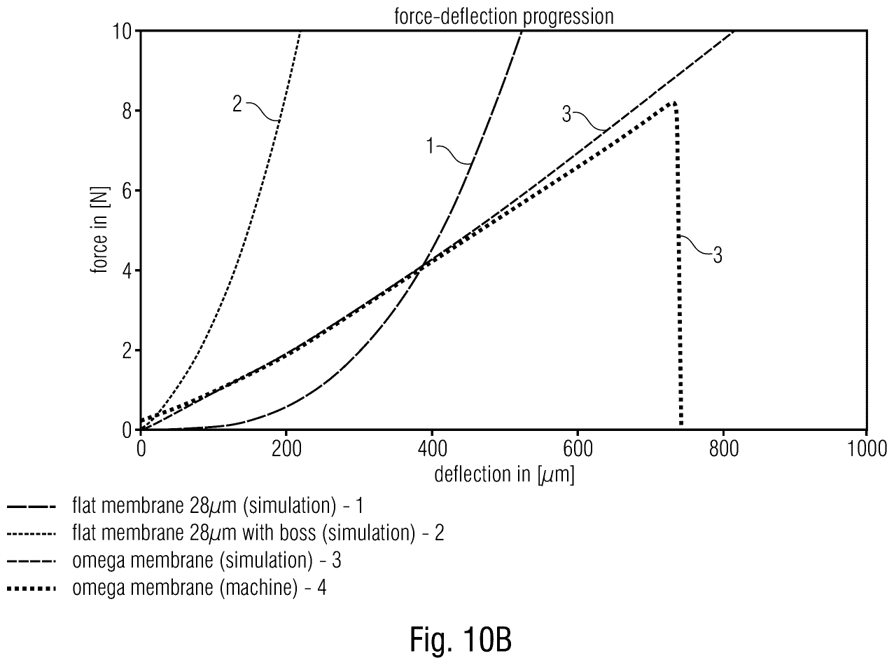

FIGS. 10a-b now show force-path diagrams of the inventive spring structure compared to conventional silicon membranes (from simulations).

FIG. 10a exemplarily shows a force-path diagram of the planar membrane (1+2—blue, and 3+4—black) and the omega membrane (green) from simulations. The continuous curve shows the maximum deflection in the center of the plane membrane and a plane membrane stiffened with a boss, while the dotted curve shows the minimum deflection of the omega membrane (5+6—green).

FIG. 10b exemplarily shows a force-path diagram of the manufactured omega membrane under a central effect of force (tensile testing machine) (4—red) compared to the simulation results (of the planar membrane (1—blue and 2—black) and the omega membrane (3—green)).

The simulation results show that there is a large difference in the characteristic curves in a pressure application between the planar membrane and the omega membrane. In contrast to the planar membranes, the pressure-path characteristic curve shows an almost linear progression for the omega membrane.

Furthermore, experiments were able to confirm these (theoretical) predictions. The experiments of the pressure application show that the measured pressure-path curves of the omega membrane mostly match the simulated results and are significantly more linear than in the case of a conventional planar membrane.

Even though some aspects of the present disclosure have been described as features related to a device, it is clear that such a description can also be considered as a description of corresponding features of a method. Although some aspects have been described as features related to a method, it is clear that such a description can also be considered as a description of corresponding features of a device or functionality of a device. Some or all of the method steps may be performed by a hardware apparatus (or using a hardware apparatus), such as a microprocessor, a programmable computer, or an electronic circuit.

In some embodiments, some or more of the method steps may be performed by such an apparatus. Depending on particular implementation requirements, embodiments of the invention may be implemented in hardware or in software or at least partially in hardware or at least partially in software.

In the foregoing detailed description, various features have been grouped together in examples in part to rationalize the disclosure. This type of disclosure is not to be interpreted as intending that the claimed examples have more features than are expressly stated in each claim. Rather, as the following claims reflect, the subject-matter may lie in fewer than all of the features of a single disclosed example. Consequently, the following claims are hereby incorporated into the detailed description, wherein each claim may stand as its own separate example. While each claim may stand as its own separate example, it should be noted that although dependent claims in the claims refer back to a specific combination with one or more other claims, other examples also include a combination of dependent claims with the subject-matter of any other dependent claim or a combination of any feature with other dependent or independent claims. Such combinations are included unless it is stated that a specific combination is not intended. It is further intended that a combination of features of a claim with any other independent claim is also encompassed, even if that claim is not directly dependent on the independent claim.

Even though specific embodiments have been illustrated and described herein, it will be apparent to one skilled in the art that a variety of alternative and/or equivalent implementations may be substituted for the specific embodiments shown and illustrated herein without departing from the subject-matter of the present application. This application text is intended to cover all adaptations and variations of the specific embodiments described and discussed herein. Therefore, the subject-matter of the present application is limited only by the wording of the claims and the equivalent embodiments thereof.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Method for manufacturing a spring structure, comprising:
providing a mold substrate and a cover substrate comprising a glass material, said mold substrate and said cover substrate being connected, wherein a surface area of the mold substrate and/or of the cover substrate is structured to form a closed surrounding cavity between the cover substrate and the mold substrate,
tempering the cover substrate and the mold substrate to decrease the viscosity of the glass material of the cover substrate, and providing an overpressure in the closed surrounding cavity with respect to the ambient atmosphere, to cause, based on the decreased viscosity of the glass material of the cover substrate and the overpressure in the closed surrounding cavity with respect to the ambient atmosphere, bulging of the glass material of the cover substrate starting from the closed surrounding cavity to acquire a cover substrate provided with a surrounding glass bulge, and
removing the mold substrate from the cover substrate to acquire the spring structure with the surrounding glass bulge.

2. Method according to claim 1, wherein the cover substrate comprises a single homogenous glass material to form the spring structure with the surrounding glass bulge from this single homogenous glass material, wherein the surrounding glass bulge is arranged as a spring element between an outer area and an inner area of the cover substrate.

3. Method according to claim 1, wherein the surrounding cavity is configured to be circularly surrounding, elliptically surrounding, or ovally surrounding to configure a circularly surrounding, elliptically surrounding, or ovally surrounding glass bulge in tempering and providing an overpressure.

4. Method according to claim 1, wherein the surrounding cavity comprises a constant width to acquire a symmetrically surrounding glass bulge in tempering and providing an overpressure.

5. Method according to claim 1, wherein the surrounding cavity comprises a (continuously) varying width to acquire an asymmetrically surrounding glass bulge in tempering and providing an overpressure.

6. Method according to claim 1, wherein providing a mold substrate and a cover substrate comprises:
providing the mold substrate and the cover substrate, wherein the mold substrate and/or the cover substrate is structured and comprises a recess;
arranging a cover substrate on the mold substrate, and
connecting the cover substrate to the mold substrate to form the closed surrounding cavity between the cover substrate and the mold substrate.

7. Method according to claim 6, wherein connecting the cover substrate to the mold substrate is carried out in an atmosphere with a defined atmospheric ambient pressure to enclose a defined atmospheric pressure in the (at least one) closed surrounding cavity.

8. Method according to claim 1, wherein tempering and providing an overpressure are carried out as glass flow processes in a vacuum furnace to acquire a defined atmospheric overpressure in the closed cavity with respect to the ambient atmosphere.

9. Method according to claim 1, wherein the surface area of the mold substrate and/or the cover substrate is structured to form a plurality of closed surrounding cavities between the cover substrate and the mold substrate, said cavities being arranged concentrically or in parallel with respect to each other.

10. Method according to claim 9, wherein, in tempering the cover substrate and the mold substrate and providing an overpressure in the closed surrounding cavity with respect to the ambient atmosphere, based on the decreased viscosity of the glass material of cover substrate and the overpressure in the closed surrounding cavity with respect to the ambient atmosphere, bulging of the glass material of the cover substrate is caused starting from the closed surrounding cavities to acquire a cover substrate provided with a plurality of surrounding glass bulges arranged concentrically or in parallel with respect to each other.

11. Method according to claim 1, wherein removing the mold substrate is carried out by means of an etching process.

12. Method according to claim 1, wherein, in removing the mold substrate by means of an etching process, interdigital structures are selectively formed in the mold substrate.

13. Method according to claim 1, wherein the spring structure comprises the surrounding glass bulge between an outer area and an inner area of the cover substrate, further comprising:
manufacturing a vertical offset between the outer area and the inner area of the spring structure, comprising:
post-tempering the cover substrate provided with the bulge to decrease the viscosity of the glass material of the cover substrate provided with the bulge, and
applying a force onto the inner area of the spring structure in the direction of the bulge to create the vertical offset between the outer area and the inner area of the spring structure.

14. Spring structure, comprising:
a glass substrate,
wherein the glass substrate comprises a surrounding glass bulge between an outer area and a deflectable inner area of the glass substrate, wherein the surrounding glass bulge is effective as a spring element between the outer area and the inner area.

15. Spring structure according to claim 14, wherein the spring element is arranged between the outer area and the inner area and surrounds the inner area, and
wherein the inner area is deflectable with respect to the outer area by means of the spring element configured as the surrounding glass bulge.

16. Spring structure according to claim 14, wherein the cover substrate comprises a single homogenous glass material to form the spring structure from this single homogenous glass material.

17. Spring structure according to claim 14, wherein the surrounding glass bulge comprises a cross section in the form of a superimposed circular segment.

18. Spring structure according to claim 14, wherein the surrounding glass bulge is circularly surrounding, elliptically surrounding, or ovally surrounding.

19. Spring structure according to claim 18, wherein the surrounding glass bulge comprises a constant width and height to form a symmetrically surrounding glass bulge.

20. Spring structure according to claim 18, wherein the width and height of the surrounding glass bulge vary to form an asymmetrically surrounding glass bulge.

21. Spring structure according to claim 14, comprising a cover substrate provided with a plurality of surrounding glass bulges that are arranged concentrically or in parallel with respect to each other.

22. Method for manufacturing a capacitive pressure sensor, comprising:
performing the method for manufacturing a spring structure according to claim 1,
connecting the outer area of the spring structure to a base substrate to form a hermetically closed cavity between the spring structure and the base substrate, wherein the inner area of the spring structure and the opposite surface area of the base substrate are spaced apart so that the inner area of the spring structure is deflectable within the cavity with respect to the base substrate,
wherein a capacitive structure is arranged at the base substrate opposite the deflectable inner area of the spring structure and the capacitive structure is formed to provide, on the basis of a deflection of the inner area of the spring structure, a capacitive change that is dependent on the deflection.

23. Method according to claim 22, wherein the base substrate comprises a recess, and wherein the recess of the base substrate is part of the cavity, and the inner area of the spring structure is deflectable with respect to the recess.

24. Method according to claim 22, wherein the inner area is arranged so as to be vertically offset with respect to the outer area of the spring structure so that the inner area of the spring structure is deflectable within the cavity with respect to the base substrate.

25. Method according to claim 22, comprising:
arranging a surrounding spacer outside of the bulge between the outer area of the spring structure and the base substrate to provide a vertical distance between the outer area of the spring structure and the base substrate.

26. Method according to claim 22, wherein
the capacitive structure is arranged in the form of capacitive metallization structures at the base substrate opposite the deflectable inner area of the spring structure, or
the capacitive structure is arranged in the form of highly doped doping areas in the base substrate, comprising the semiconductor material, opposite the deflectable inner area of the spring structure.

27. Method according to claim 22, comprising:
depositing a metallization as a capacitively effective structure on the main surface area, facing away from the glass bulge, of the inner area of the spring structure.

28. Method according to claim 22, further comprising:
forming interdigital structures on the main surface area, facing away from the glass bulge, of the inner area of the spring structure,
wherein a corresponding capacitive interdigital structure is arranged at the base substrate opposite the inner area of the spring structure.

29. A capacitive pressure sensor comprising:
the spring structure according to claim 14,
wherein the outer area of the spring structure is connected to a base substrate to form an hermetically closed cavity between the spring structure and the base substrate, wherein the inner area of the spring structure and the opposite surface area of the base substrate are spaced apart so that the inner area of the spring structure is deflectable with respect to the base substrate, and
wherein a capacitive structure is arranged at the base substrate opposite the deflectable inner area of the spring structure, and the capacitive structure is configured to provide, based on a vertical deflection of the inner area of the spring structure, a capacitive change that is dependent on the deflection.

30. Capacitive pressure sensor according to claim 29, wherein the base substrate comprises a recess, and wherein the recess of the base substrate is part of the cavity, and the inner area of the spring structure is deflectable with respect to the recess.

31. Capacitive pressure sensor according to claim 29, wherein the inner area is arranged so as to be vertically offset with respect to the outer area of the spring structure so that the inner area of the spring structure is deflectable within the cavity with respect to the base substrate.

32. Capacitive pressure sensor according to claim 29, comprising:
arranging a surrounding spacer outside of the bulge between the outer area of the spring structure and the base substrate to provide the vertical distance between the outer area of the spring structure and the base substrate.

33. Capacitive pressure sensor according to claim 29,
wherein the capacitive structure comprises capacitive metallization structures at the base substrate opposite the deflectable inner area of the spring structure, or
wherein the capacitive structure comprises highly doped doping areas in the base substrate, comprising a semiconductor material, opposite the deflectable inner area of the spring structure.

34. Capacitive pressure sensor according to claim 29, comprising:
a metallization on the main surface area, facing the cavity, of the intermediate area of the spring structure.

35. Capacitive pressure sensor according to claim 29,
wherein the capacitive structures comprise a capacitive interdigital structure at the base substrate opposite the deflectable inner area of the spring structure, and
wherein corresponding interdigital structures are further arranged on the main surface area, facing the cavity, of the intermediate area of the spring structure.
